(19) United States
(12) Patent Application Publication
(10) Pub. No.: US 2016/0157446 A1
(43) Pub. Date: Jun. 9, 2016

(54) MULTIPLE SOIL-TOPOGRAPHY ZONE FIELD IRRIGATION USER INTERFACE SYSTEM AND METHOD

(71) Applicant: CROPX Technologies LTD., Herzliya (IL)

(72) Inventor: Itzhak BENTWICH, Nelson (NZ)

(21) Appl. No.: 14/962,162

(22) Filed: Dec. 8, 2015

Related U.S. Application Data
(63) Continuation-in-part of application No. 14/440,950, filed on May 6, 2015.
(60) Provisional application No. 62/088,950, filed on Dec. 8, 2014.

(30) Foreign Application Priority Data
Nov. 6, 2012 (NZ) 603449

(51) Int. Cl. A01G 25/16; G05B 15/02; G06F 3/01

(52) U.S. Cl. CPC A01G 25/167; G06F 3/011; G05B 15/02

(57) ABSTRACT

A field irrigation interface display method constituted of: receiving an indication of an irrigation status of a respective one of a plurality of soil-topography zones of a field; controlling a display of a user device to display a graphical illustration of the field split into the plurality of soil-topography zones; controlling the display of the user device to display thereover an informational graphical illustration associated with the received indication of the respective soil-topography zone; controlling the display of the user device to display a first actionable graphical illustration of a first irrigation attribute of the respective soil-topography zone; and responsive to a user gesture at any one of the displayed first actionable graphical illustrations, outputting a first irrigation adjustment signal arranged to adjust the amount of irrigation provided by a particular one of a plurality of irrigation device sets to the respective soil-topography zone.

### CROSS REFERENCE TO RELATED APPLICATIONS

The current application is a continuation-in-part of U.S. patent application Ser. No. 14/440,950, filed May 6, 2015 and titled “METHOD AND SYSTEM FOR AUTOMATED DIFFERENTIAL IRRIGATION”, which is a national phase of PCT application S/N PCT/NZ2013/000197, filed Nov. 6, 2013. PCT application S/N PCT/NZ2013/000197 claims priority from New Zealand provisional patent application S/N 603449, filed Nov. 6, 2012 and titled “Precision Irrigation Scheduling”. The current application additionally claims priority to U.S. provisional application Ser. No. 62/088,950, filed Dec. 8, 2014 and titled “A COMPUTER-BASED USER INTERFACE SYSTEM AND METHOD FOR A USER-ASSISTED AUTOMATED DIFFERENTIAL IRRIGATION”. The entire contents of each of the above documents are incorporated herein by reference.

### TECHNICAL FIELD

The invention relates generally to the field of agricultural irrigation, and in particular to an irrigation user interface.

### BACKGROUND

Various systems for automated agricultural irrigation are known. Many inventions have been described for hardwired required for differential irrigation (a.k.a VRI, variable rate irrigation). Many precision agriculture and farm management software packages are similarly known in the art. None of these offer automated differential irrigation planning.

### SUMMARY OF THE INVENTION

Accordingly, it is a principal object of the present invention to overcome at least some of the disadvantages of prior art advertisement display methods and systems. In various preferred embodiments, a method is provided for reducing the amount of water required to irrigate an agriculture field, by applying different amounts of water to different parts of the field, based at least in part on an analysis of spatial soil properties of the field including topological features, and extrapolation of data from soil sensors placed in different parts of a field.

A preferred embodiment provides a computerized differential irrigation system comprising: a computerized Topography Integrated Ground watEr Retention (TIGER) map generator receiving at least the following inputs: a topographical input describing topographical features of an area to be irrigated; and an electromagnetic input describing conductive features of the area to be irrigated, and in which the computerized Topography Integrated Ground watEr Retention (TIGER) map generator includes: a computerized topographic feature processing functionality providing information relating to at least one of slope, aspect and catchment area features of said area to be irrigated; and a computerized topographic feature utilization functionality employing at least one of slope, aspect and catchment area features of the area to be irrigated for automatically ascertaining water retention at a plurality of different regions within the area to be irrigated; and a computerized computing functionality employing the Topography Integrated Ground watEr Retention (TIGER) map together with at least current outputs of wetness sensors located at the plurality of different regions within the area to be irrigated to generate a current irrigation plan; and a computerized irrigation control subsystem automatically utilizing the current irrigation map to control irrigation within the area to be irrigated based on the current irrigation instructions and to cause different amounts of water to be provided to the different regions within the area to be irrigated.

The present disclosure further provides a computerized irrigation planning system comprising: a computerized Topography Integrated Ground watEr Retention (TIGER) map generator receiving at least the following inputs: a topographical input describing topographical features of an area to be irrigated; and an electromagnetic input describing conductive features of the area to be irrigated, and in which the computerized Topography Integrated Ground watEr Retention (TIGER) map generator includes: a computerized topographic feature processing functionality providing information relating to at least one of slope, aspect and catchment area features of the area to be irrigated; and a computerized topographic feature utilization functionality employing the at least one of slope, aspect and catchment area features of the area to be irrigated for automatically ascertaining water retention at a plurality of different regions within the area to be irrigated; and a computerized computing functionality employing the Topography Integrated Ground watEr Retention (TIGER) map together with at least current outputs of wetness sensors located at the plurality of different regions within the area to be irrigated to generate a current irrigation plan.

The present disclosure further provides an automated Topography Integrated Ground watEr Retention (TIGER) map generating system comprising: a data input interface receiving at least the following inputs: a topographical input describing topographical features of an area to be irrigated; and an electromagnetic input describing conductive features of the area to be irrigated, computerized topographic feature processing functionality automatically deriving from the inputs, information relating to at least one of slope, aspect and catchment area features of the area to be irrigated; and computerized topographic feature utilization functionality employing the at least one of slope, aspect and catchment area features of the area to be irrigated for automatically ascertaining water retention at a plurality of different regions within the area to be irrigated.

The present disclosure also provides an automated soil type classification system comprising: an input interface receiving: offline pre-existing laboratory generated soil drying curves, which indicate at least the following parameters for a plurality of different types of soils: field capacity, wilting point and refill point; and empirical field drying curves for a field for which irrigation is to be planned; and a computer operated automatic correlator employing the offline pre-existing laboratory generated soil drying curves and the empirical field drying curves for a field for which irrigation is to be planned to automatically provide a soil type map for the field for which irrigation is to be planned.

The present disclosure also provides a computerized differential irrigation system comprising: a computerized Topography Integrated Ground watEr Retention (TIGER) map generator receiving at least the following inputs: a topographical input describing topographical features of an area to be irrigated; and an electromagnetic input describing conductive features of the area to be irrigated, and in which the computerized Topography Integrated Ground watEr Retention (TIGER) map generator includes: a computerized automatic soil type analysis functionality which obviates the need for laboratory testing of soil in the area to be irrigated.

The present disclosure also provides a computerized irrigation efficiency metric generating system comprising: a computerized Topography Integrated Ground watEr Retention (TIGER) map generator receiving at least the following inputs: a topographical input describing topographical features of an area to be irrigated; and an electromagnetic input describing conductive features of the area to be irrigated, and in which the computerized Topography Integrated Ground watEr Retention (TIGER) map generator includes: a computerized topographic feature processing functionality providing information relating to at least one of slope, aspect and catchment area features of the area to be irrigated; and a computerized topographic feature utilization functionality employing the at least one of slope, aspect and catchment area features of the area to be irrigated for automatically ascertaining water retention at a plurality of different regions within the area to be irrigated; and a computing functionality employing the Topography Integrated Ground watEr Retention (TIGER) map together with at least current outputs of wetness sensors located at the plurality of different regions within the area to be irrigated to generate a current irrigation plan; and an irrigation efficiency analyzer operative to: ascertain an amount of water required to irrigate the area based on the current irrigation plan; ascertain an amount of water required to irrigate the area if differential irrigation is not employed; and calculate an irrigation efficiency metric representing a water saving produced by employing the current irrigation plan.

The present disclosure further provides a multiple soil-topography zone field irrigation user interface comprising: an input module arranged to receive an indication of an output of each of a plurality of sensors, each sensor arranged to output an indication of an irrigation status of a respective one of a plurality of soil-topography zones of a field; a display module arranged to: control a display of a user device to display a graphical illustration of the field split into the plurality of soil-topography zones; control the display of the user device to display, over the graphical illustration each of the plurality of soil-topography zones, an informational graphical illustration associated with the received indication of the output of the sensor of the respective soil-topography zone; and control the display of the user device to display, for each of the plurality of soil-topography zones, a first actionable graphical illustration of a first irrigation attribute of the respective soil-topography zone, and an irrigation adjustment module arranged, responsive to a user gesture at any one of the displayed first actionable graphical illustrations, to output a first irrigation adjustment signal, wherein the output first irrigation adjustment signal is arranged to adjust the amount of irrigation provided by a particular one of a plurality of irrigation devices to the respective soil-topography zone.

The present disclosure also provides methods of using any one of the described and/or claimed systems within the body of this disclosure.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning, i.e. they will be taken to mean an inclusion of not only the listed components which the use directly references, but also to other non-specified components or elements.

Additional features and advantages of the invention will become apparent from the following drawings and description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIG. 1 illustrates a simplified schematic diagram, which provides an overview of a differential irrigation system constructed and operative in accordance with certain embodiments;

FIG. 2 illustrates a simplified schematic diagram, which illustrates creation of a Topography Integrated Ground watEr Retention (TIGER) zone map in accordance with certain embodiments;

FIG. 3 illustrates a simplified schematic diagram, which illustrates operation of an automated soil type ascertaining process;

FIG. 4 illustrates a simplified schematic diagram, which illustrates operation of an irrigation logic process;

FIG. 5 illustrates a simplified schematic diagram, which illustrates an embodiment that controls a drip irrigation system;

FIG. 6 is a simplified schematic diagram, which illustrates ascertaining an Irrigation Water Utilization Metric (IWUM) in accordance with a preferred embodiment, which is useful in optimizing water pricing and allocation by a water provider;

FIG. 7 illustrates an example of the Topography Integrated Ground watEr Retention (TIGER) zone map 115 of FIG. 1;

FIG. 8 illustrates results of the automated soil type ascertaining process 270 of FIG. 2;

FIG. 9 illustrates screens of a mobile computing app, constructed and operated in accordance with a preferred embodiment;

FIGS. 10A-10H illustrate various views and screen shots of a multiple soil-topography zone field irrigation user interface, according to certain embodiments; and

FIG. 11 illustrates a high level flow chart of a multiple soil-topography zone field irrigation user interface display method, according to certain embodiments.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

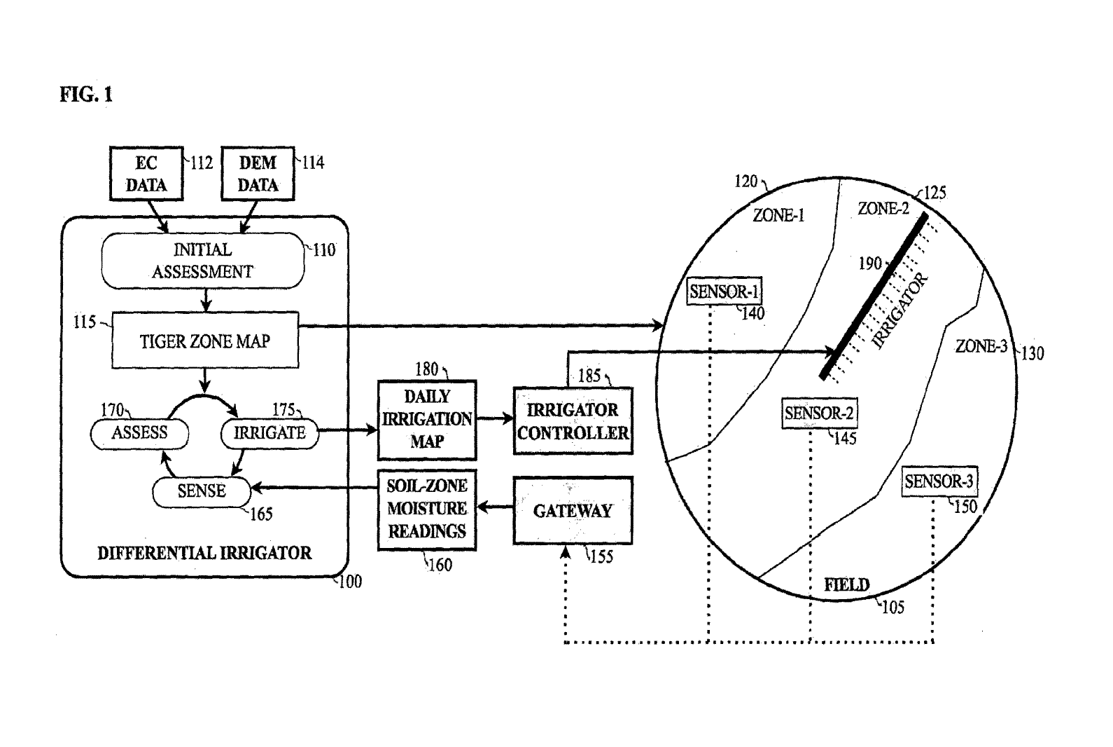

FIG. Reference is now made to FIG. 1, which is a simplified schematic diagram providing an overview of the present disclosure.

Irrigation planning for large fields, the process of deciding how much water to apply onto which part of a large field and when—is known in the art to be a complex process, and one which has never been successfully automated. The hardware required for such irrigation is available, and one example is known as Site-specific Variable Rate Irrigation (SS-VRI or VRI). But an automated process to maximize the value of such variable rate irrigation, or differential irrigation—at present doesn't exist. Much has been studied and known about the various factors affecting irrigation needs. But, the process of analyzing these various factors, for a specific field, crop and climate, and automatically transforming them into an effective automated irrigation plan, remains a process which until the present has defied automation, and requires site specific, manual, ongoing expert analysis.

A recent review Evans et. a I, Review: Adoption of site-specific variable rate sprinkler irrigation systems (Irrig. Sci 2013), states, inter alia,: “The development of algorithms, sensor specifications, and placement criteria and decision support systems for SS-VRI is still in their infancy. General, broad-based, intuitive, and easily adjusted software (decision support) for implementation of prescriptions for SS-VRI systems is not available for a multitude of crops, climatic conditions, topography, and soil textures. The complexity in optimizing multi-objective, multivariate ‘(irrigation) prescriptions for dynamically changing management zones will be a substantial challenge for researchers, industry, and growers alike”.

In fact, the current process of planning differential irrigation is at present so far from automation and so dependent on skilled manual expertise, that the above review concludes, inter alia, that “specialized, continual training on the hardware, software, and advanced agronomic principles is needed now for growers, consultants, dealers, technicians, and other personnel on how to define management zones (areas), write prescriptions, and develop seasonal crop irrigation management guidelines. This has been slowed because the criteria for training individuals to develop management zones, write appropriate crop-specific prescriptions, and assist with the decision-making processes have yet to be defined.”

Current irrigation logic methodology tries to assess as many of the complex factors affecting irrigation, either using sensors to measure them, or models to predict them. These include crop factors (crop type and phase), climate factors (temperature, humidity, wind, etc.) and soil factors (soil type, soil water retention capacity, and soil moisture). The complexity of this information is such, that it cannot be automatically ‘resolved’ into an irrigation plan. Rather, the ‘raw’ information is then presented to the farmer who would consult it, and then manually decides how to irrigate.

This challenge is much greater in large fields. Irrigation-logic needs of small domestic gardens or vegetable patches may be adequately addressed by relatively simple soil-moisture sensors ‘closed-loop’ systems. Such systems simply use a soil moisture sensor and irrigate to replenish a desired soil-moisture threshold. But extending them to large fields would require dozens of soil-sensors under a single irrigator, often hundreds across a farm, which would be both cost prohibitive as well as would interferes with field cultivation, such as plowing.

The present inventors have realized that would be very useful if there was an accurate map charting the ‘water holding’ properties of a field (for example, clay retains more water than sand). If such a map existed, it would be possible to divide the field into effective irrigation zones, and monitor soil moisture in each of these zones, knowing that the same soil moisture is expected to be found everywhere within this zone. Irrigation could then be guided accordingly.

The accepted way of attempting to create such irrigation management zones, relies on Electro-Conductivity (EC) mapping, also referred to as Electro-Magnetic (EM) mapping, a procedure which measures the conductivity of soil and thereby gives an indication of its water content, and which is further described herein below.

The inventors earlier tried to develop such a reliable ‘water holding’ map of a field based on EC mapping, in order to guide irrigation—and they have failed. In their study (Hedley, AGWAT 2009) they created and tested the effectiveness of irrigation zones based directly on Electro-Conductivity mapping of a field, using the accepted methodologies for EC mapping and data analysis. They then installed 50 soil moisture sensors, 50 meters apart, in a grid across the 32 hectare field studied, expecting to prove that there is little variance between the soil moisture readings within each of three EC-based soil-zones. This would indicate that the zoning is effective, and mean that it is then possible to use a single sensor in a zone, and expect its measurements to reflect the soil moisture across the entire zone.

Unfortunately, the results indicated that in fact there was a significant variance between sensor readings within each of the EC-based zones, and little to no difference between the zones (mean and standard deviation (SD) were identical in two EC-based irrigation zones, and less than 1 SD different from the third zone, with % coefficient of variation (% CV) in all three zones ranging between 9% and 14%). This observation is further validated by the fact that there was little variance between multiple readings the same sensor over time, indicating that the sensors themselves are reliable.

The present disclosure proposes a different method of producing a novel, reliable water retention potential map, referred to here as a Topography Integrated Ground watEr Retention (TIGER) map, and dividing it into effective irrigation management zones that accurately reflect water retention properties. This method is based on a novel computerized method of analysis and integration, which analyzes topographical terrain attributes, and integrates them with an analysis of EC mapping data. The Topography Integrated Ground watEr Retention (TIGER) zone map of the present invention for the first time, allows automation of the differential irrigation planning process, as illustrated in FIG. 1.

In accordance with a preferred embodiment, a differential irrigator 100, which preferably is embodied in an automated irrigation decision support software module running on a general purpose computer, or on a mobile computing and or communication device in conjunction with an internet-based computing server, is used to enable efficient irrigation of a field 105, by differentially irrigating different parts of the field 105. It is typically the case that the soil composition and the topography of agricultural fields are not homogeneous, and hence different parts of the field often require different amounts of irrigation.

In accordance with a preferred embodiment, the differential irrigator 100 preferably initially performs a one-time initial assessment 110 of the field 105, based at least in part on Electro-Conductivity Mapping Data, designated EC data 112 and topographical Digital Elevation Mapping Data, designated DEM data 114, both of the field 105. EC data is preferably obtained from EM mapping. EM mapping measures the apparent electrical conductivity of soil through the use of electromagnetic sensors that are towed on the surface soil of a field, typically by a quad bike, which is fitted with RTK GPS. The EM sensor uses a transmitting coil that induces a magnetic field that varies in strength according to soil depth. A receiving coil reads primary and secondary induced currents in the soil. It is the relationship between these primary and secondary currents that measures soil conductivity. EM mapping may be performed using commercially available EM mapping hardware, such as Geomatrix' EM31 and EM38, data is processed into an EC map using publicly available software. It may also be obtained from service providers that provide both EM sensing service in the field, as well as processing the obtained data into an EC map. A recent report summarizes the current practices, and illustrates examples of suitable equipment, and service providers (‘Standards for Electromagnetic Induction mapping in the grains industry’, GRDC Precision Agriculture Manual, Australia 2006).

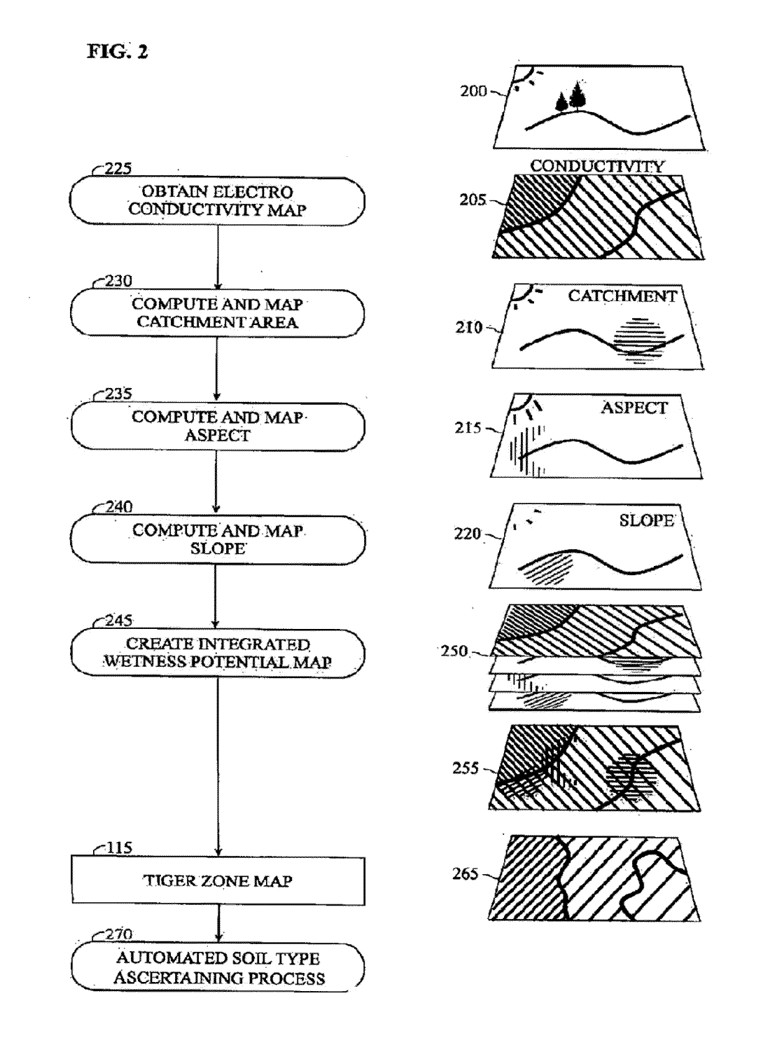

DEM data 114 may also be obtained from EM mapping output, since DEM data is typically collected as part of the EM survey, since EM survey is typically performed using a RTK GPS, which logs DEM data 115. It is important to note that DEM data 114 is unrelated to EC data, and is typically discarded in the prior art. Alternatively, DEM data 114 may be obtained from other sources of DEM data 114, including databases of DEM data 114, instruments that record DEM data 114 and services of DEM data 114 mapping. EC data 112 and DEM data 114 and the modes for obtaining them are further described herein below with reference to FIG. 2.

The initial assessment 110 generates a Topography Integrated Ground watEr Retention (TIGER) zone map 115, which preferably provides for each location in the field 105, a soil wetness potential score, reflecting relative ‘potential for retaining water’ of this location in the field 105, relative to all other locations therein. This soil wetness potential score is based on an analysis of EC data 112 and DEM data 114, and reflects a calculation of an integrated effect of physical soil properties, reflected in the EC data 112, and of topographical terrain attributes, which are calculated based an analysis of the DEM data 114), both of the field 105.

The Topography Integrated Ground watEr Retention (TIGER) zone map 115 preferably also divides the field 105 into several irrigation zones according to their soil wetness potential score. In a preferred embodiment of the present invention, the several irrigation zones, typically three irrigation zones, zone-1 120, zone-2 125 and zone-3 130. Each one of these irrigation zones preferably has soil-physics properties and topographical terrain attributes that indicate that it would retain water differently and hence require different amount and timings of irrigation from each one of the other irrigation zones.

The Topography Integrated Ground watEr Retention (TIGER) zone map 115 is preferably also used to define one or more suitable locations for placing one or more soil sensors within each of zone-1 120, zone-2 125 and zone-3 130. In a preferred embodiment of the present invention, sensor-1 140 is a sensor node, located within zone-1 120, sensor-2 145 is a sensor node located within zone-2 125, and sensor-3 150 is a sensor node located within zone-3 130.

In a preferred embodiment of the present invention, a location determined by the Topography Integrated Ground watEr Retention (TIGER) zone map 115 for sensor-1 140 is such that based at least in part on measurements of sensor-1 140, the differential irrigator 100 can effectively predict an irrigation condition of the entire zone-1 120. The same is true for sensor-2 145 and sensor-3 150 and their corresponding zone-2 125 and zone-3 130. Each of sensor-1 140, sensor-2 145 and sensor-3 150—is a sensor node that preferably comprises one or more sensors. In a preferred embodiment of the present invention, each sensor node may comprise two soil moisture sensors, installed at two different soil depths, depending on crop type. In a preferred embodiment of the present invention, each node also comprises a temperature sensor. The initial assessment 110 and the Topography Integrated Ground watEr Retention (TIGER) zone map 115 are further described herein below with reference to FIG. 2. Sensor-1 140, sensor-2 145 and sensor-3 150 are preferably connected, preferably wirelessly, preferably via a gateway 155 to the differential irrigator 100. In a preferred embodiment of the present invention, other sensors, including but not limited to sensors operative to detect rainfall, climatic conditions, and plant parameters, may also be utilized and similarly connected to the differential irrigator 100; these are not required for operation of the present invention, but may be useful in improving its performance.

Once the installation described hereinabove is complete, the differential irrigator 100 preferably enables effective irrigation of the field 105, through the following iterative process.

A step designated SENSE 165, receives measurements from each of sensor-1 140, sensor-2 145 and sensor-3 150. These measurements preferably represent a soil moisture and an irrigation condition of zone-1 120, zone-2 125 and zone-3 130 respectively.

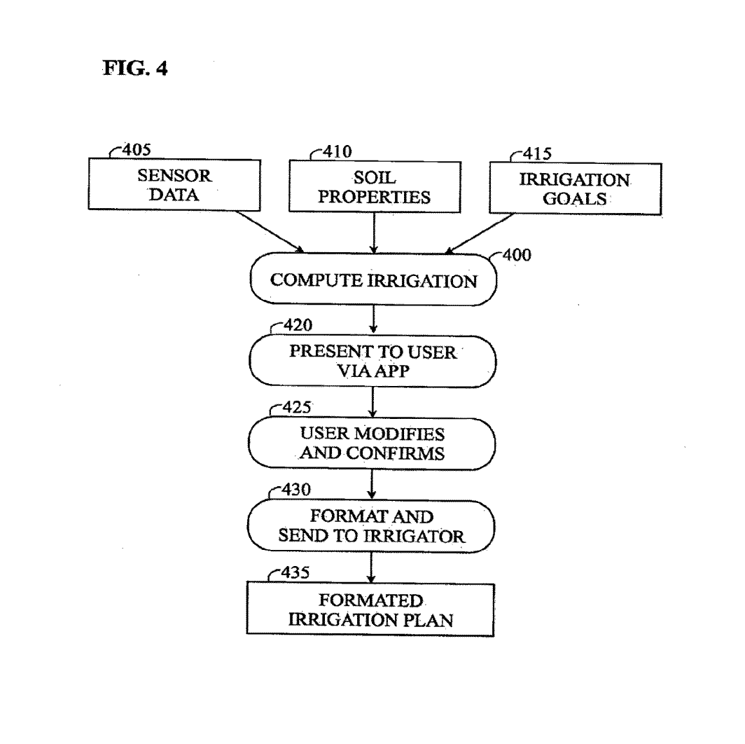

Next, a step designated ASSESS 170 assesses the measurements received from each of the sensor-1 140, sensor-2 145 and sensor-3 150. Based at least in part on these measurements, assess 170 determines an amount of irrigation appropriate for each of zone-1 120, zone-2 125 and zone-3 130, which amounts of irrigation may preferably be different from one another. Preferred operation of ASSESS 170 is further described hereinbelow with reference to FIG. 4.

Finally, a step designated IRRIGATE 175, preferably communicates a daily irrigation map 180 to an irrigator controller 185, which controls an irrigator 190. The irrigator 190 may preferably be a mechanized irrigation device, such as a pivot irrigator, a lateral move irrigator, or other. The irrigator 190 then irrigates the field 105 accordingly. Preferred operation of IRRIGATE 175 is further described hereinbelow with reference to FIG. 4.

In a preferred embodiment, this iterative process of SENSE 165, ASSESS 170 and IRRIGATE 175, may be performed at scheduled intervals, such as daily. In other preferred embodiments of the present invention, it may take place following each irrigation event, or prior to each planned irrigation event, or upon demand of a user of the system.

Reference is now made to FIG. 2, which is a simplified schematic diagram illustrating the rationale and operation of the initial assessment 110 of FIG. 1.

Reference numeral 200 designates a schematic image depicting a field to be irrigated which is non-flat topologically. Judging by its external appearance, it appears quite ‘normal’. Its vegetation appears quite uniform. It does not seem to be different from other fields, which have a similar external appearance. Current irrigation systems would irrigate a field like this uniformly, or at best—would base irrigation exclusively on EC data 112. The present invention takes a different approach, through an appreciation that EC data 112 is not the only factor affecting the wetness of the ground and takes into account topographic terrain attributes, which significantly influence soil water retention and hence irrigation. Harnessing an analysis of these various features produces the Topography Integrated Ground watEr Retention (TIGER) zone map 115, which enables automation of differential irrigation planning. These topographic terrain attributes and the method by which they are analyzed and integrated with the EC data are further described herein below.

Reference numeral 205 designates a schematic image depicting an EC map of the field of schematic image 200, showing EC-based irrigation management zones. While the field of 200 seems ‘normal’, underlying it is the EC data, which indicates different soil zones. Reference numeral 210 designates a schematic image depicting catchment area mapping of the field of image 200. A catchment area is an area that is topographically lower than its surroundings, the soil of which tends to be more ‘soggy’.

Reference numeral 215 designates a schematic image depicting ‘aspect mapping’ of the field of image 200: Aspect mapping indicates the extent of exposure to the sun and utilizes the fact that areas that are facing the sun, receive more solar radiation and hence dry up more rapidly than those that don't.

Reference numeral 220 designates an schematic image depicting ‘slope mapping’ of the field of image 200 and utilizes the fact that areas that have a steeper slope retain water differently than ones of moderate slopes. It is appreciated from schematic images 205-220 that there are multiple factors affecting the water-retention properties of the field of 200.

Reference numeral 225 designates a schematic image depicting the superimposition of the four above mentioned datasets: EC mapping 205, catchment mapping 210, aspect mapping 215 and slope mapping 220. In accordance with a preferred embodiment of the present invention at least one and preferably all of the aforesaid mappings are integrated into a single coherent map, the Topography Integrated Ground watEr Retention (TIGER) map.

As noted above, reference numeral 205 depicts an Electro Conductivity (EC) map of the same field, divided into three irrigation zones, based on the EC data. EC data may be derived from Electro-Magnetic (EM) mapping. EM mapping is acquired using EM sensors, such as Geonics EM38Mk2 and EM31 sensors, which are preferably combined with RTK-DGPS and dataloggers mounted on an all-terrain vehicle to acquire high resolution EM38 and EM31 vertical mode datasets in two separate surveys. A Trimble Agl70 field computer may be used for simultaneous acquisition of high resolution positional and ECa data.

The sensors preferably measure a weighted mean average value for apparent electrical conductivity (EC) to 1.5 m depth (EM38) and 5.0 m depth (EM31). Survey data points are preferably collected at 1-s intervals, at an average speed of 15 kph, with a measurement recorded approximately every 4 m along transects 10 m apart. Filtered data comprising latitude, longitude, height above mean sea level and ECa (mSnrf <1>) may preferably be imported into ArcGIS (Environmental Systems Research Institute, (ESRI© 1999). Points are preferably kriged in Geostatistical Analyst (ESRI© 1999) using a spherical semivariogram and ordinary kriging to produce a soil ECa prediction surface map. Three management zones may preferably be defined on this map (using Jenks natural breaks) for further soil sampling. EM surveys quantify soil variability largely on a basis of soil texture and moisture in non-saline conditions.

A process designated compute and map catchment area 230 computes a catchment layer 210, which is a spatial representation of the Catchment Area value of every point in the field 105. A catchment area is defined as the In(a/tan 3) where is the local upslope area draining through a certain point per unit contour length and tan is the local slope. A location has a high catchment area value when it is topographically depressed relative to its surrounding area. Accordingly, a soil in a location which has a high catchment area value tends to retain more water and be ‘more soggy’. As an example, water would more likely accumulate at the bottom of a valley than at the top of a hill. There are various methods to compute catchment.

In a preferred embodiment, the surface and subsurface runoff is parameterized by catchment area estimations. The catchment area (CA), defined as the discharge contributing upslope area of each grid cell and the specific catchment area, defined as the corresponding drainage area per unit contour width are computed using the multiple flow direction method of FREEMAN (1991). In another preferred embodiment the SAGA Wetness Index is used in conjunction with the Topographic Wetness Index (TWI). SWI is similar to TWI but it is based on a modified catchment area calculation (out.mod.carea), which does not treat the flow as a thin film as done in the calculation of catchment areas in conventional algorithms. As a result, the SWI tends to assign a more realistic, higher potential soil wetness than the TWI to grid cells situated in valley floors with a small vertical distance to a channel. A computer code is then preferably used to integrate the different predictors, remove sinks, and correct for overlapping results. The computer code performing the calculation of catchment area, in a way that has been found effective in predicting irrigation management zones and is enclosed as computer code listing.

A process designated compute and map aspect 235 computes the aspect layer 215, which is a spatial representation of a set of ‘aspect’ values of every point in the field 105. By aspect, is meant in which direction the land is facing. As an example, land facing the sun, will dry faster and hence require more water than land facing away from the sun. A process designated compute and map slope 240 computes the aspect layer 220, which is a spatial representation of the slope in value in degrees of every point in the field 105. As an example, steeper sloped land will require a different amount of water than flatter land. Computer code performing the calculation of slop and of aspect, in a way that has been found effective in predicting irrigation management zones and is enclosed as computer code listing.

Having calculated the above mentioned four datasets, conductivity score map 205, catchment score map 210, aspect score map 215 and slope score map 220, the next step is create the Topography Integrated Ground watEr Retention (TIGER) map. It is appreciated that each one of these maps on its own is not useful for guiding irrigation. It is further appreciated, as images 250 and 255 illustrate, that simply overlying these maps one on top of the other, is similarly not useful. The following algorithm and methodology is preferably used in order to carefully analyze each data point in each of these datasets, integrating them to generate an integrated wetness potential map 115.

It is appreciated that each of the above datasets 205-220 is a map of the field 105, wherein each location in this map of the field 105 is associated with a value. As an example, the catchment score map 210 comprises a catchment score for each point in the map. Same is true for the EC value map, aspect score value map and slope value map. To integrate these scores, a large set of vectors is created, corresponding to all locations in the field 105 which are investigated, for example all locations for which EC data 112 and DEM data 114 has been obtained. This set of vectors is designated vector pool. Each vector preferably comprises eight attributes: a location property (its location within the field 105, preferably an x location and a y location, and a set of six measured or calculated attributes, relating to the above mentioned four data sets: superficial EC score, deep EC score, catchment score, aspect score, slope score, and elevation (as per DEM data 114 for that location). Importantly, elevation is not associated with soil wetness, but has been found to be an important attribute, useful in creating the integrated wetness potential map 115, as described herein below.

A number of vectors are randomly selected. Each of these serves as a nuclei of an integrated wetness potential score zone. In a preferred embodiment of the present invention, the number of initial tentative nuclei is preferably 100, providing a detailed map of the integrated wetness potential scores in the field 105. In another preferred embodiment, the number of initial nuclei is preferably a much smaller number: a desired number of irrigation zones, typically 3 or 4. In yet another preferred embodiment, the number may be double the number of the desired irrigation zones, so as to have within each irrigation zone an ‘inner zone’, in which the sensors are to be placed, so that sensors are placed in a location which best represents the irrigation zone they are in.

Each vector in the vector pool is assessed for its distance to the each of the nuclei, and added to the closest nuclei. By distance is meant an integrated distance, that is a distance which takes into account the distance of each attribute of the vector to that attribute in each of the nuclei. In a preferred embodiment of the present invention, this distance may preferably be calculated as a squared error function.

When all vectors in the pool have been thus assigned to nuclei, the barycenter of each nucleus is calculated, and the process of assessing each vector in the vector pool to a nucleus and assigning it to the nearest nucleus is repeated. With each iteration, the centre of the nuclei of each further optimized. This process is repeated until the location of the centre of the nuclei does not move between iteration. In a preferred embodiment of the present invention, the process is preferably repeated 1000 iterations.

In a preferred embodiment, a function describing the calculation performed in evaluating the integrated effect of each location in each of the conductivity score map 205, catchment score map 210, aspect score map 215 and slope score map 220—on each corresponding location the integrated wetness potential map 115—may be described calculated as follows:

$$J = {\sum }_{j = 1}^{k} {\sum }_{i = 1}^{n} {‖ {x}_{i}^{( j )} - {c}_{j} ‖}^{2}$$

where K is the number of zones, N is number of vectors (i.e. locations evaluated in the field 105), X is an attribute, and i is the type of attribute.

It is appreciated that topographical terrain attributes other than the ones listed above may be used to calculate the integrated wetness potential map 115, and that the above mentioned ones are provided as an example only and are not meant to be limiting. It is further appreciated that the above description of methodology of integrating topographical terrain attributes and EC data may be performed using other methodologies, and that the above methodology is provided as an example only and is not meant to be limiting.

The Topography Integrated Ground watEr Retention (TIGER) zone map 115, and the irrigations zones therein, may preferably be represented in suitable formats, including but not limited to polygons and shape-files. Conversion into such formats is well known in the art, for example using a ‘Raster-to-Polygons’ and ‘Polygon-to-Shapefile’ in ‘R’ Programming language (www.r-project.org). Such formats are useful for comparing the irrigation zones to other data and for communicating with irrigation system controllers and other agricultural systems.

According to a preferred embodiment, if more than one crop is grown in the field 105 under the same irrigator 190, than the irrigation zones may preferably divided into soil-crop zones, such that there is only one crop per irrigation zone. As an example, if there are two crops, wheat and corn, grown within single soil-topography irrigation zone ‘A’, then this zone ‘A’ would preferably be divided into zone ‘A-Wheat’ and zone ‘A-Corn’. This, since the water uptake and hence irrigation balance of these two crops may be different, and hence would require separate sensors monitoring them, and separate irrigation planning logic.

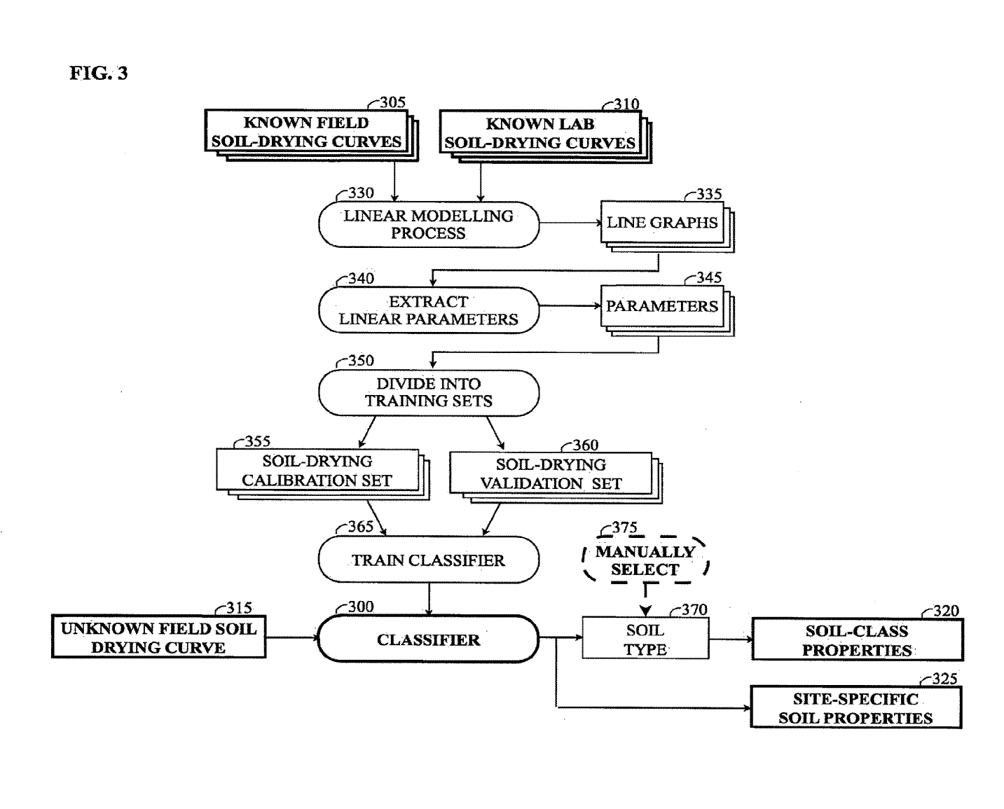

Lastly, for each of the irrigation zones determined in the Topography Integrated Ground watEr Retention (TIGER) zone map 115, a soil type is determined, by a process designated an automated soil type ascertaining process 270, which is further described herein below, with reference to FIG. 3.

Accuracy of the the initial assessment 110 and Topography Integrated Ground watEr Retention (TIGER) zone map 115 both of FIG. 1 was validated in the field as follows. Three replicate soil samples (at three depth intervals) were randomly collected from each of the three classes identified from the Topography Integrated Ground watEr Retention (TIGER) zone map 115, avoiding spray truck and irrigator tracks. The soil samples were intact soil cores (100 mm diameter and 80 mm in height) taken from the middle of three sample depths (0-200 mm, 200-400 mm, 400-600 mm) for laboratory characterisation of bulk density and soil moisture release characteristics (at 10 kPa); and smaller cores (50 mm diameter and 20 mm in height) were taken for soil moisture release at 100 kPa. A bag of loose soil was also collected (0-200 mm, 200-400 mm, 400-600 mm soil depth) for laboratory estimation of permanent wilting point (1500 kPa) (Burt, 2004) and particle size distribution. Total available water holding capacity (AWC) was estimated as the difference between volumetric soil moisture content (mcv) at 1 OkPa and 1500 kPa, where 1 OkPa is taken as field capacity and 1500 kPa is wilting point. Readily available water holding capacity (RAWC) was estimated as the difference between mcv at 1 OkPa and at 1 OOkPa. Percent sand, silt and clay was determined on these soil samples by organic matter removal, clay dispersion and wet sieving the >2-mm soil fraction and then by a standard pipette method for the <2-mm soil fraction (Claydon, 1989).

Table 1 summarizes some significant measured differences between the soil hydraulic characteristics of the three classes identified from the Topography Integrated Ground watEr Retention (TIGER) zone map 115 of FIG. 1. These measured differences reflect differences in pore size distribution and justify the efficacy of the Topography Integrated Ground watEr Retention (TIGER) zone map 115, as the basis for management of irrigation. An increasing Available Water Capacity (AWC) with class number reflects an increasing proportion of pores in the range where plant-available water is stored, in particular readily available water which is stored between 1 OkPa and 1 OOkPa (pore size diameters 0.03-0.003 mm).

TABLE 1
Soil texture and hydraulic characteristics (±standard deviation)
of soils in the three management classes

| | Soil moisture release at | | | | | | |
|---|---|---|---|---|---|---|---|
| | 10 kPa | 100 kPa | 1500 kPa | RAWC* | AWC* | Sand | Clay |
| Class | m³m⁻³ | m³m⁻³ | m³m⁻³ | m³m⁻³ | m³m⁻³ | % | % |
| 1 | 0.11 ± | 0.06 ± | 0.03 ± | 0.05 ± | 0.08 ± | 96 | 2 |
| | 0.02 | 0.01 | 0.00 | 0.02 | 0.02 | | |
| 2 | 0.14 ± | 0.09 ± | 0.03 ± | 0.05 ± | 0.11 ± | 95 | 2 |
| | 0.04 | 0.01 | 0.01 | 0.04 | 0.04 | | |
| 3 | 0.24 ± | 0.13 ± | 0.04 ± | 0.11 ± | 0.20 ± | 90 | 4 |
| | 0.02 | 0.02 | 0.00 | 0.03 | 0.02 | | |

*RAWC = readily available water-holding capacity; AWC = available water-holding capacity.

The soil moisture sensors used also tracked large differences in soil moisture between soil classes within this study area (FIG. 2), reflecting their contrasting soil moisture release characteristics, and the varying influence of a high water table, especially noticeable in Class 3 soils. Prior to commencement of irrigation in late spring 2010, the soil moisture sensors simultaneously monitored 0.11±0.06 m <3> m <3> in the dry classes (lowest EC values) compared with 0.1710.26 m <3> m <3> (intermediate EC classes) and 0.2710.64 m <3> m <3> in the wettest classes (highest EC values). The dry classes (Class 1 in FIG. 1) hold less available water and require irrigation sooner than Class 3.

For the period: February-March 2011, the depth to water table varied at any one time by about 70 cm (FIG. 2). A 66 mm rainfall event between 4th and 6th March caused the water table to rise by about 50 cm in Class 1 and 70 cm in Class 3 (FIG. 2). This difference is due to different storage capacities of the soils and landscape position. Class 3 soils occupy low-lying areas where water tends to accumulate by overland runoff and lateral flow, and the water table is closest to the surface. These soils, typically being wetter, require less rainfall to bring them to saturation; and once saturated the water table rises to the surface, at a faster rate than in soils starting at a drier soil moisture content.

Continuous soil moisture sensor recordings, at 15 minute intervals during an entire irrigation season, from a network of 9 sensors, placed in the different irrigation zones defined by the Topography Integrated Ground watEr Retention (TIGER) zone map 115, provided an unprecedented high resolution temporal dataset, confirming the efficacy of the Topography Integrated Ground watEr Retention (TIGER) zone map 115 and providing important input for its fine-tuning.

In another preferred embodiment, predictive modelling of an underground water table may be useful, preferably using a random forest regression trees data mining algorithm (RF, Breiman, 2001). This approach and experiments validating its are useful is described as follows. The use of EM38, EM31, digital elevation and rainfall data were investigated for incorporating into the predictive models. Rainfall data was obtained from the closest weather station (six kilometres away), and rainfall was assumed constant over the study area at any one time. TWI and SWI were extracted from the digital elevation map (see 2.3). The data was fused by projecting it onto a common grid, and modelling the co-variates in space. Two predictive modelling approaches were developed and compared to explain observed patterns of water table depth and soil moisture status, i.e. a simple approach using multiple linear regression (MLM), and a data-mining approach using random forest regression trees (RF, Breiman, 2001).

Three predictors have been selected to dynamically model soil moisture content and water table depth: EM38, SWI and rainfall. EM38 and SWI data have been log-transformed to overcome skewness, as modelling approaches assume normal distribution. The rainfall data have been integrated over three days to account for the time required for the rain event to fully affect water table depth. These variables were selected as the best predictors, and other attributes, including elevation, EM31 and TWI, although tested, did not improve model predictions, and were therefore not included, with our objective being to develop the best parsimonious prediction model.

Reference is now made to FIG. 3, which is a simplified schematic diagram illustrating operation of automated soil type ascertaining process 270.

As is known in the art, different types of soils have different water release properties. For example, clay retains water well, whereas sand does not. These soil water release properties are typically studied in the lab, for example by taking intact soil core samples, drying them under lab conditions, and recording the release of water from the soil over time, also known as a soil-drying curve. Such curves are useful in guiding irrigation. Of special importance are three points that are on the curve and are derived from it. Field Capacity is the maximal amount of water which the soil can retain without runoff. At Wilting Point plants will wilt. And Refill Point, which is calculated based on these two, represents the level of water in the soil, below which irrigation is needed.

Refill Point and Field Capacity are useful in controlling irrigation; since a goal of efficient irrigation is preferably to maintain a soil moisture level that is in the range between these two. A severe limitation of existing irrigation solutions is that these values can currently only be obtained through a manual scientific laboratory process, which is therefore expensive. Importantly, it also prevents automation of the irrigation planning process.

The automated soil type ascertaining process 270 is a novel automated process to determine the soil type of irrigation zones in the field 105, without requiring a manual laboratory process. This process is preferably an automated process which trains a classifier 300, using a set of known field soil-drying curves 305 and preferably a set of known ]ab soil-drying curves 305. Once trained, the classifier 300 is operative to analyze an unknown Field soil-drying curve and determine its soil-class properties 320, or its site specific soil properties 325, as further explained herein below.

The classifier 300 is preferably embodied in machine learning computer software. In a preferred embodiment of the present invention the classifier 300 may preferably be a Decision Tree algorithm. It is appreciated however that there are many powerful, easily applicable machine learning methodologies, algorithms and tools known in the art, and the following embodiment described is provided as an example only and is not meant to be limiting.

Each one of the known Field soil-drying curves 305, is a set of soil-moisture measurements along a time axis, made in the field, by a soil-moisture sensor, in a soil type. These measurements may be plotted as a soil drying curve. The set of known Field soil-drying curves 305 comprises of a plurality of such soil drying curves, from each of a plurality of locations and soil types.

Similarly, each one of the known lab soil-drying curves 305, is a set of soil-moisture measurements along a time axis, but ones which were made in the laboratory, where the water content in the soil is accurately measured by weighing the soil sample as it is being dried in an oven. The set of known lab soil-drying curves 305 comprises of a plurality of such sets of moisture measurements, or soil drying curves, taken from each of a plurality of locations and soil types. Preferably, as least part of the known Field soil-drying curves 305 and the known lab soil-drying curves 310 are taken from an identical location and soil type.

In a preferred embodiment, a linear modeling process 330 fits the known Field soil-drying curves 305 and the known lab soil-drying curves 310 to corresponding plurality of line graphs 335. For each of the line graphs 335, an extract LINEAR parameters 340 process is performed, which derives parameters 345, preferably an Intercept and a Slope of each of the line graphs 335. The parameters 345 are a convenient abstraction of each of the known Field soil-drying curves 305 and the known lab soil-drying curves 310. It is appreciated that the classifier 300 may be trained on curves directly using various methodologies well known in the art, and may also be trained on abstractions or models other than the linear modeling process 330, which is provided as an example only.

In a preferred embodiment, a divide into training sets 350 process, divides the parameters 345 derived from the known Field soil-drying curves 305 into two datasets: a soil-drying calibration set 355 and a soil-drying validation set 360. In another preferred embodiment of the present invention, the parameters 345 derived from the known lab soil-drying curves 310 are similarly divided into these two datasets.

The train classifier 365 process uses the soil drying calibration set 355 and the soil drying validation set 360, to train the classifier 300. The classifier 300 is trained to identify patterns which appear in the soil-drying calibration set 355, and then tests its success in identifying these patterns, on the soil drying validation set 360. In a preferred embodiment, the soil drying calibration set 355 and the soil drying validation set 360 may preferably be grouped by their soil type, and or by other criteria, and the classifier 300 may be trained to identify a drying curve, or its abstraction, which typifies this drying curve in the soil type.

Various methodologies are known in the art to train machine learning classifiers and other comparable software algorithms. These include, but are not limited to: an iterative process of training and validation, processes in which the training and validation sets are dynamically changed and overlap, and other methodologies. It is appreciated therefore that the description herein of the training of the classifier 300 are simplified and provided as an example only and are not meant to be limiting.

Once trained, the classifier 300 is operative to analyze an unknown Field soil-drying curve 315 and based on this analysis to determine a soil type 370 to which the unknown Field soil-drying curve 315 corresponds. By soil-class, is meant soil type of a ‘class’ of soils, such as ‘clay’, ‘sand’, ‘sandy-loam’ etc. It is understood, that as an example, soil in two different farms may be classified as ‘sandy loam’ in both, although there may be a difference between the ‘sandy loam’ of one, compared to the other.

In various preferred embodiments of the present invention a list of 8-12 of following soil types, is preferably used, and their Field Capacity and Wilting Point values may preferably be used (v %):

| Texture | Capacity | Wilting |
|---|---|---|
| Sand | 10 | 5 |
| Loamy sand | 12 | 5 |
| Sandy loam | 18 | 8 |
| Sandy clay loam | 27 | 17 |
| Loam | 28 | 14 |
| Sandy clay | 36 | 25 |
| Silt loam | 31 | 11 |
| Silt | 30 | 6 |
| Clay loam | 36 | 22 |
| Silty clay loam | 38 | 22 |
| Silty clay | 41 | 27 |
| Clay | 42 | 30 |

In another preferred embodiment, the classifier 300 determines SITE-SPECIFIC soil properties 325 of the unknown Field soil-drying curve 315. As mentioned above, grouping soils into ‘classes’ such as ‘Clay loam’ etc., is a generalization, whereas in fact the soil in each site has its own specific water retention properties. These are referred to here as SITE-SPECIFIC soil properties 325.

As is known in the art, the accuracy, sensitivity and specificity of a machine learning classifier depends on the size and quality of the training and validation sets and on the quality of the unknown sample to be analyzed. The accuracy of the classifier 300 increases over time, as it continues to be trained by the train classifier 365. Its increasing accuracy over time is further facilitated by two factors. First, the known Field soil-drying curves 305 is constantly growing, as more users use the system. This, since the system continuously streams all readings from all sensors of all users to its central data repository, and thus accumulates a growing number of soil-drying curves, obtained from various soil types. Second, over time, the readings from a specific irrigation zone in a specific farm also accumulate. Over time, therefore, the unknown Field soil-drying curve 315, rather than being a single curve, may preferably be a plurality of soil-drying curves obtained from the same location. Providing as input such a plurality of ‘natural variants’ of the sample to be identified greatly increases the accuracy of a classifier, as is well known in the art.

According to another preferred embodiment, the soil type 370 may be obtained by the farmer-user manually selecting a type of soil, as designated by manually select 375. The differential irrigator 100 may preferably be implemented as a computer-web application or more preferably as mobile-web application, wherein clear guidelines describe the differences between preferably 8-12 types of soil. Preferably, short videos and photographs guide the farmer in selecting the correct type of soil-class.

Reference is now made to FIG. 4, which is a simplified schematic diagram illustrating operation of ASSESS 170 and IRRIGATE 175, both of FIG. 1.

A compute irrigation process 400 preferably receives as input, sensor data 405, soil properties 410 and irrigation goal 415. The sensor data 405 comprises readings received from soil moisture and other sensors, such as sensor-1 140, sensor-2 145 and sensor-3 150 all of FIG. 1. The soil properties 410, comprises soil-class properties 320 and site-specific soil properties 325 both of FIG. 3, including field capacity and refill point properties. The irrigation goals 415 preferably comprises user defined guidelines, indicating up to which soil moisture level the user would like to irrigate, preferably relative to the field capacity and refill point values of the soil of the zone in which the sensor is located. In a preferred embodiment of the present invention, the user may provide as one of the irrigation goals 415, a percentage number, relating to the range between refill point and field capacity. Irrigation goals 415 may comprise global irrigation goals and crop specific irrigation goals.

The compute irrigation 400 compares each sensor reading received, with the soil propertied of the soil of the irrigation zone, and the irrigation goal defined by the user, and calculates accordingly the recommended irrigation for that zone. Next step, present to user via app 420, preferably presents a tentative irrigation map, for each of the zones of the field 105 of FIG. 1, preferably via an app on a mobile device, or a computer, or a web browsing device.

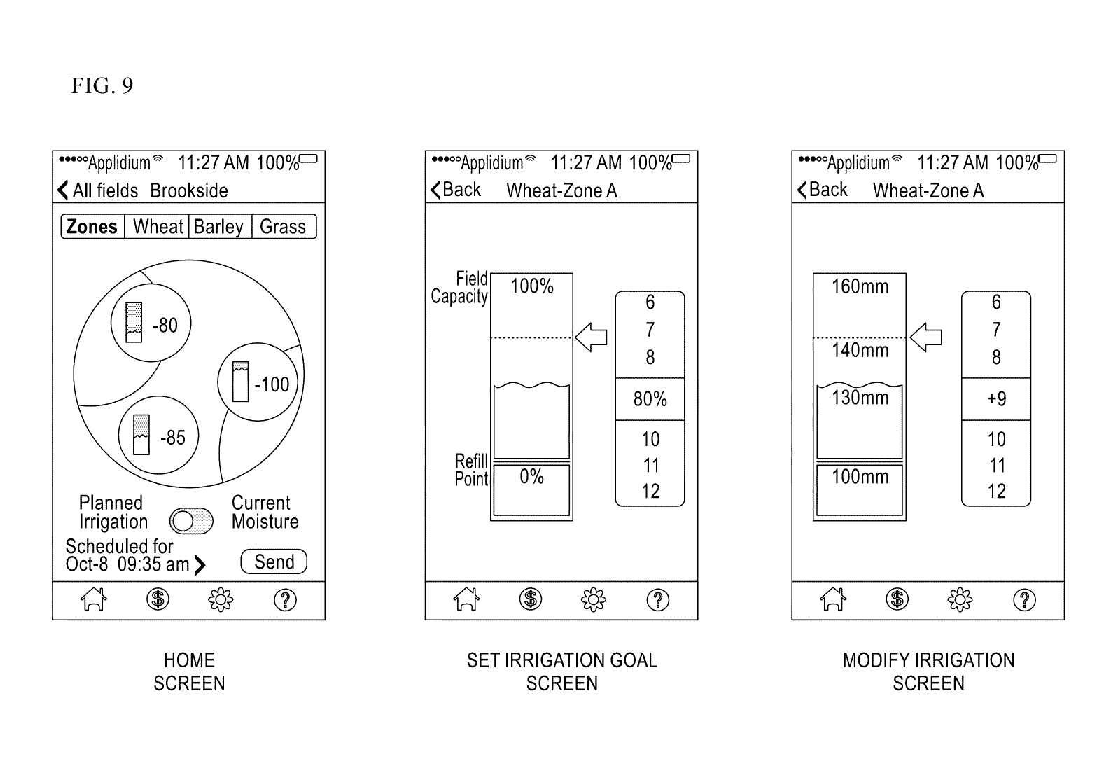

A step designated user modifies and confirms 425 allows the user to review the irrigation recommendation, and very simply modify it. In a preferred embodiment, this modification may be performed via the mobile app, preferably using under 4 or less clicks and or gestures, in most cases. FIG. 9 presents several screen layouts of an app constructed and operative in accordance with a preferred embodiment of the present invention, illustrating the total automation, and simplicity and ease of use, with which steps present to user via app 420 and user modifies and confirms 425, are preformed.

Format and send to irrigator 430 illustrates operation of IRRIGATE 175 of FIG. 1. This process formats the irrigation map approved by the user in the previous step, in to a formatted irrigation plan 435, such that it is suitable for the irrigator controller 185 and the irrigator to the irrigator 190. It is appreciated that there are different types, brands and providers of mechanical irrigators, such as pivot irrigators and lateral move irrigators. As an example, the format and send irrigator 430 may format formatted irrigation map 435 as a ‘full-VRI’ map (that is, where every point in the field may receive a different amount of irrigation), or to pivot speed or section control irrigator (that is, where different sectors of a circular field, receive different amounts of irrigation), for section or speed control of lateral move irrigator (that is, where different cross-sections of a rectangular field receive different amounts of irrigation. In another preferred embodiment of the present invention, the format and sent to irrigator 430 may provide an amount to irrigate, to be applied uniformly onto a field, such that the irrigation is optimized based on the assessment of the irrigation needs of each part of the field, and preferably one or more user preferences. This step also formats the irrigation map to the technical format, suitable for a specific vendor of an irrigator 190 or irrigator controller 185.

Reference is now made to FIG. 5, which is a simplified schematic diagram illustrating embodiment that guides a drip irrigation system.

In accordance with another preferred embodiment, the differential irrigator 100 of FIG. 1 may automatically control differential irrigation of the field 105, through use of a drip irrigation system.

In this embodiment, the Topography Integrated Ground watEr Retention (TIGER) zone map 115 preferably also defines a pattern for laying drip irrigation pipes, such that a separate drip irrigation pipe is placed in each of the irrigation zones, zone-1 120, zone-2 125 and zone-3 130. This pattern for laying drip irrigation pipes allows a farmer to LAY DRIP PIPES 118 accordingly: a pipe designated zone-1-PIPE 131 in zone-1 120, a pipe designated zone-2-PIPE 132 in zone-2 125, and a pipe designated zone-3-PIPE 133 in zone-3 130.

Each of the three pipes preferably connect to a corresponding tap: zone-1-PIPE 131 connects to TAP-1 134, zone-2-PIPE 132 connects to TAP-2 135, zone-3-PIPE 133 connects to TAP-3 136.

In a preferred embodiment, TAP-1 134, TAP-2 135 and TAP-3 136 are remotely operated taps, preferably controlled by the irrigator controller 185. Similar to the process described hereinabove with reference to FIG. 1, the differential irrigator 100 operates in an automated iterative manner: sense 165 receives measurements from each of sensor-1 140, sensor-2 145 and sensor-3 150. assess 170 assesses these measurements and determines an amount of irrigation appropriate for each of zone-1 120, zone-2 125 and zone-3 130, which amounts of irrigation may preferably be different from one another. Lastly, irrigate 175, preferably communicates the daily irrigation map 180 of FIG. 1 to the irrigator controller 185, which in turn controls TAP-1 134, TAP-2 135 and TAP-3 136, thereby delivering suitable irrigation amounts to each of zone-1 120, zone-2 125 and zone-3 130.

As mentioned hereinabove with reference to FIG. 1, in a preferred embodiment, this iterative process of sense 165, assess 170 and irrigate 175, may be performed on scheduled intervals, such as daily. In other preferred embodiments of the present invention, it may take place following each irrigation event, or prior to each planned irrigation event, or upon demand of a user of the system.

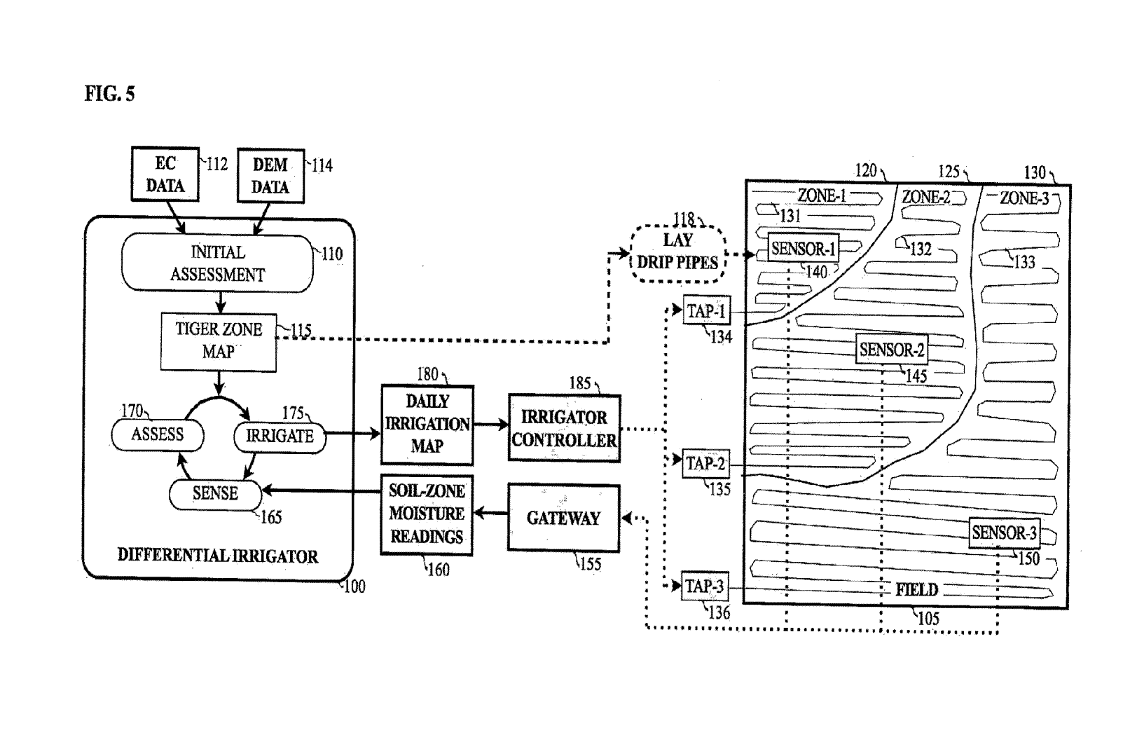

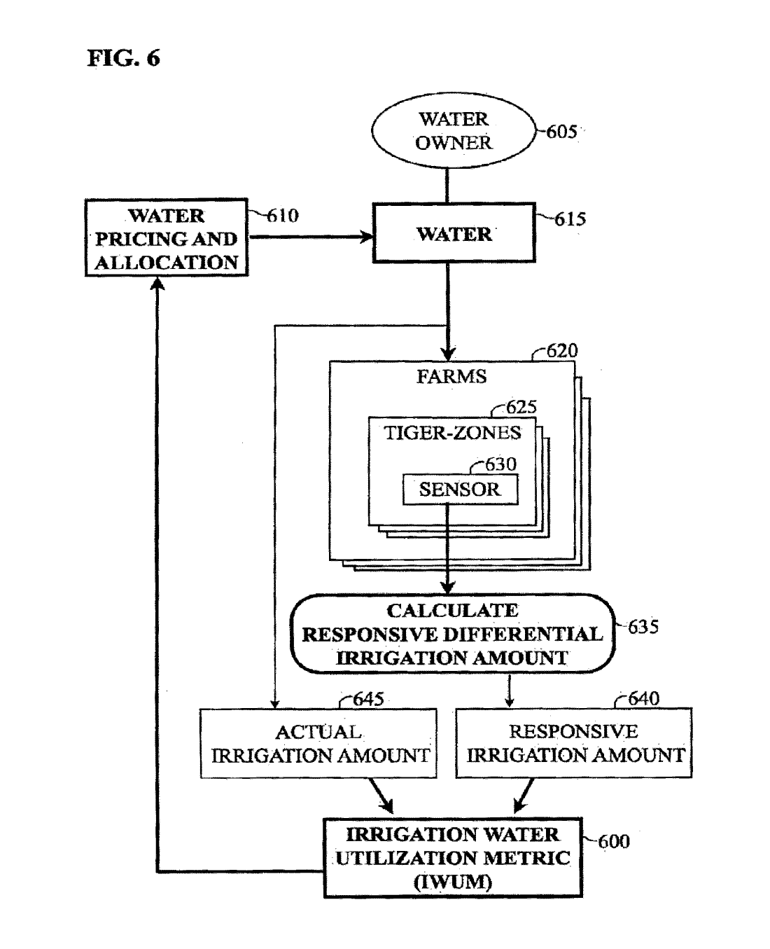

Reference is now mad to FIG. 6, which illustrates ascertaining an Irrigation Water Utilization Metric (IWUM) in accordance with a preferred embodiment, which is useful in optimizing water pricing and allocation by a water provider.

Uniform irrigation, which is the current norm, is often wasteful, since different parts of a field often have different irrigation needs. The damages from this are waste of water, reduced crop due to overwatering, and damage to ground water reservoirs through chemical leaching and waste overflow. Water owners and governments bear much of this consequence, since water provided to agriculture is often heavily subsidized or discounted. Governments and state agencies further suffer from this, by means of damage to the state's natural resources.

It would be advantageous for water owners, governments and state agencies, to have tools which allow monitoring of the efficiency with which water is used for irrigation. An important aspect of this would be a tool which monitors and grades the differential irrigation efficiency, that is to what extent irrigation of a field is optimized for the different needs of different parts of a field. Currently such tool does not exist. The present invention provides such a tool, which is described herein below.

The present disclosure provides a Irrigation Water Utilization Metric (IWUM) 600, which empowers a water owner 605 to affect a water pricing and allocation 610 of water 615 that the water owner 605 provides to each of a plurality of farms 620.

Each of the plurality of farms 620 may comprise a plurality of Topographic Integrated Ground watEr Retention zones, designated TIGER zones 625, which are derived from the

Topographic Integrated Ground watEr Retention zone map designated Topography Integrated Ground watEr Retention (TIGER) zone map 115 of FIG. 1. The differential irrigator 100 of FIG. 1 is operative to analyze and determine an amount of irrigation each of the TIGER zones 625, needs at any time, if suitable sensors are installed in each of these zones.

According to a preferred embodiment, one or more sensor 630 is preferably installed in each of the TIGER zones 625. The sensor is preferably a soil moisture sensor node, similar to sensor-1 140, sensor-2 145 and sensor-3 150 of FIG. 1, and preferably comprises two soil moisture sensors installed at two soil depths.

Using mechanisms described hereinabove with reference to FIGS. 1-4, a calculate responsive differential irrigation amount 635, may calculate a responsive irrigation amount 640 based on input from one or more sensor 630, from each of the plurality of sensor-zones 625, for any one of the farms 620. By comparing the responsive irrigation amount 640 (that is: calculating how much water would have been irrigated, if this farm would have irrigated differentially and effectively) to an actual irrigation amount 645 (that is the amount of water that this farm actually used)—the Irrigation Water Utilization Metric (IWUM) 600 is calculated. As an example, the Irrigation Water Utilization Metric (IWUM) 600 may be a ratio between the responsive irrigation amount 640 and the actual irrigation amount 645.

The Irrigation Water Utilization Metric (IWUM) 600 may then be used by a water owner 605, to affect the water allocation and pricing 610 of the water 615 provided to this one of the farms 620. It is appreciated that the Irrigation Water Utilization Metric (IWUM) 600 may be used by the water owner 605 as well as by other interested parties, in various ways, and in combination with various other elements, to govern the use of water, encourage water savings, and for other purposes, and that the above description is meant as an example only and is not meant to be limiting.

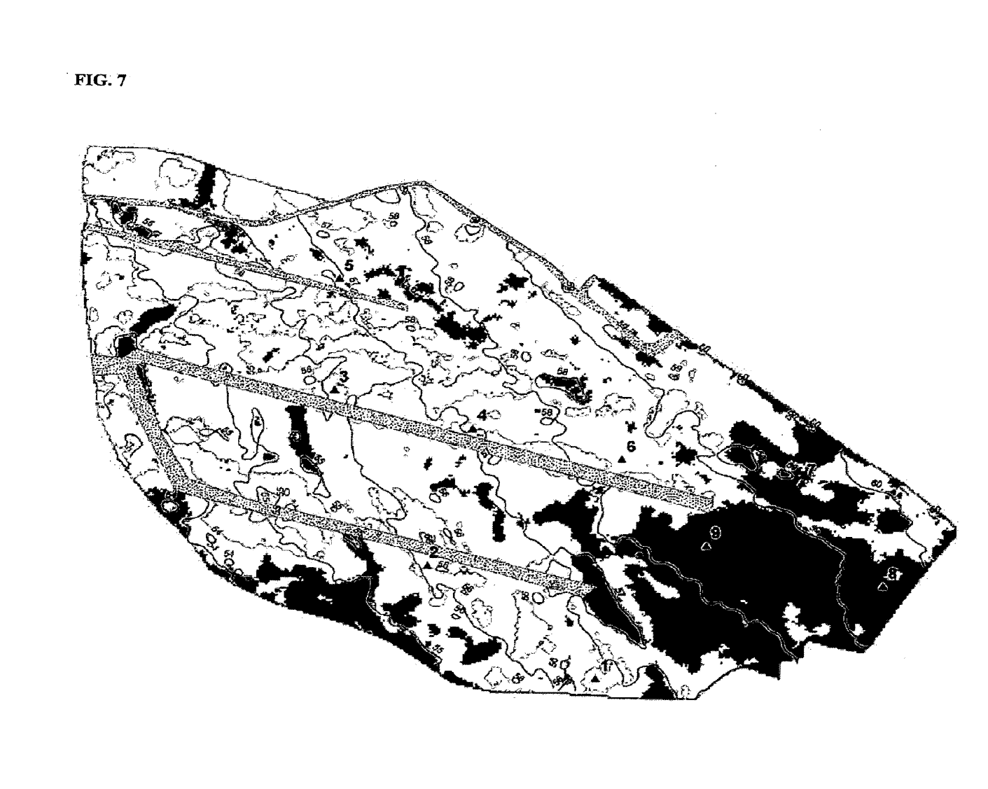

FIG. 7 illustrates an example of the Topography Integrated Ground watEr Retention (TIGER) zone map 115 of FIG. 1. It is appreciated that the map comprises of three irrigation management zones. These correspond to soil physics and soil moisture data provide hereinabove, with reference to FIG. 2.

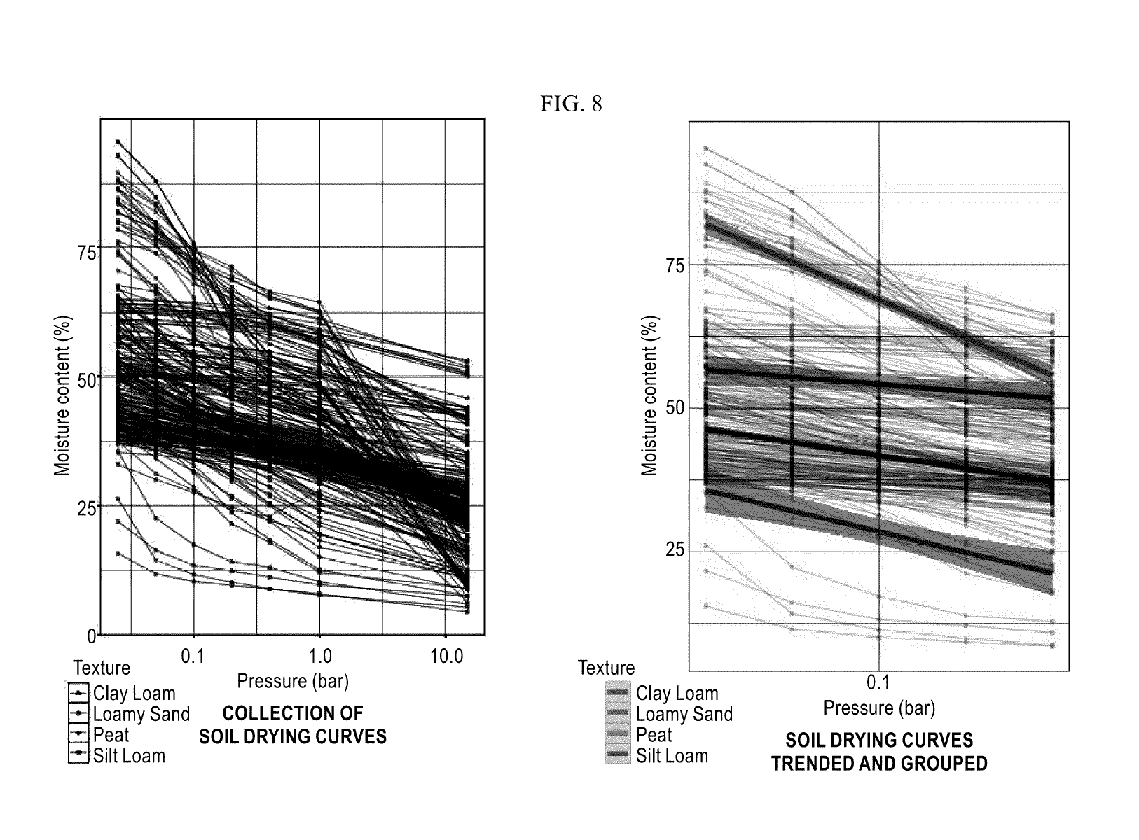

FIG. 8, which is an image of graphs of soil drying curves, illustrates results of the automated soil type ascertaining process 270 of FIG. 2. It is appreciated that the graphs depict a collection of soil drying curves; each line correlates to a specific sample (right plate). These samples are successfully trended and grouped into distinct soil class categories.

FIG. 9 illustrates screens of a mobile computing app, constructed and operated in accordance with a preferred embodiment. The screen images of the software, demonstrate the full automation of the irrigation planning process. It is appreciated that without full automation, which is provided by the differential irrigator 100 of FIG. 1, such app and screens would not be possible. As an example, many factors, climatic, plant related, time related, and soil related, would need to be displayed to the user. The user would also need to view a much larger and more detailed map of the field 105, in order to consider how to irrigate. In contrast, the app shown provides the user with simplicity of automated use, which is similar to that of a ‘television remote control’, rather than that of complicated software. It is appreciated that this simplicity cannot be achieved without the automation of differential irrigation that the present invention offers.

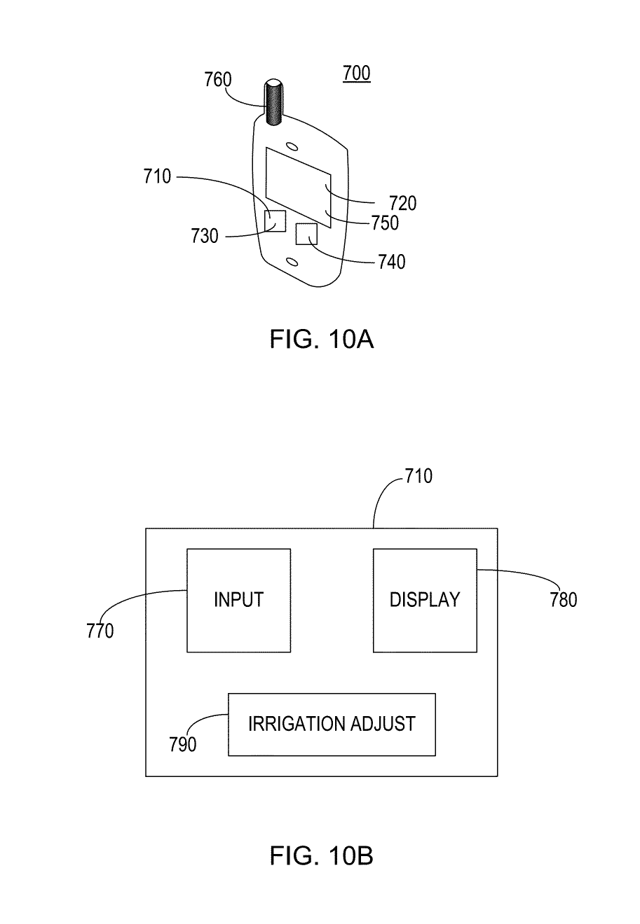

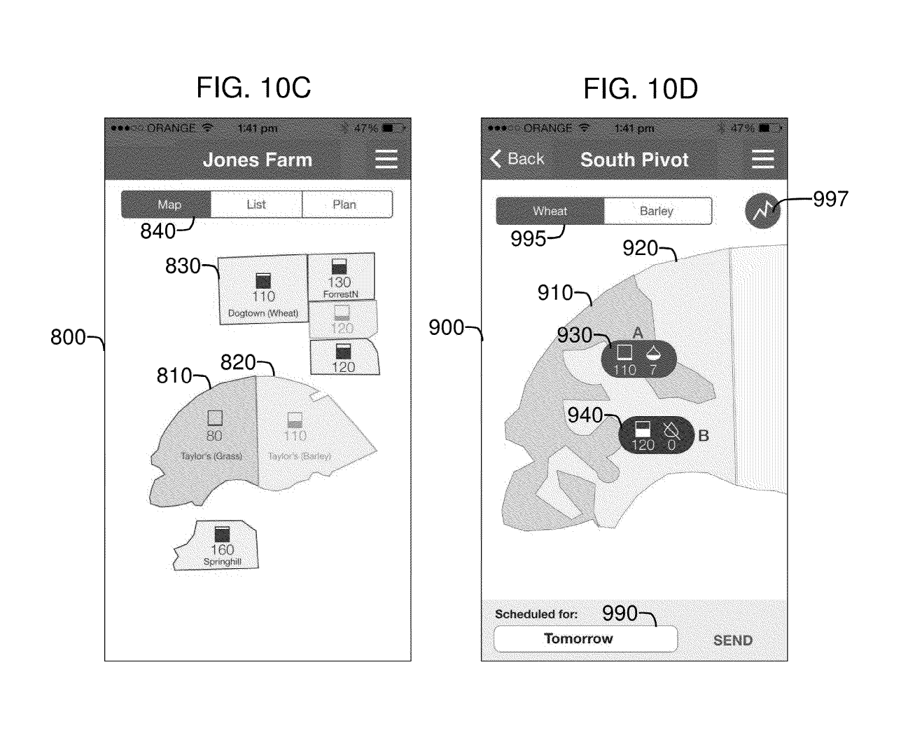

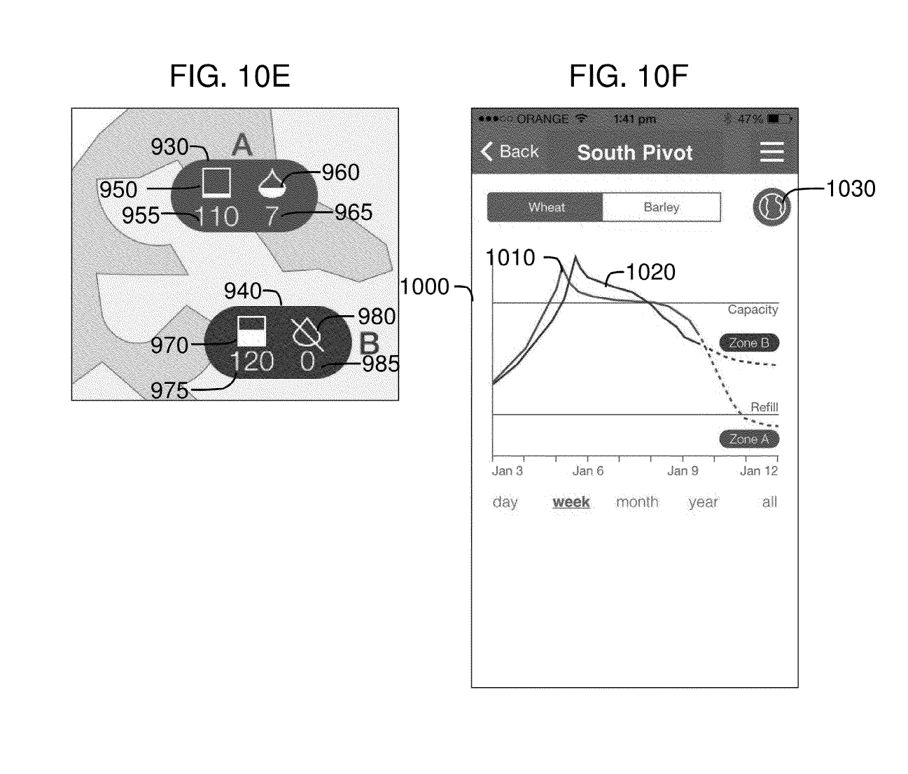

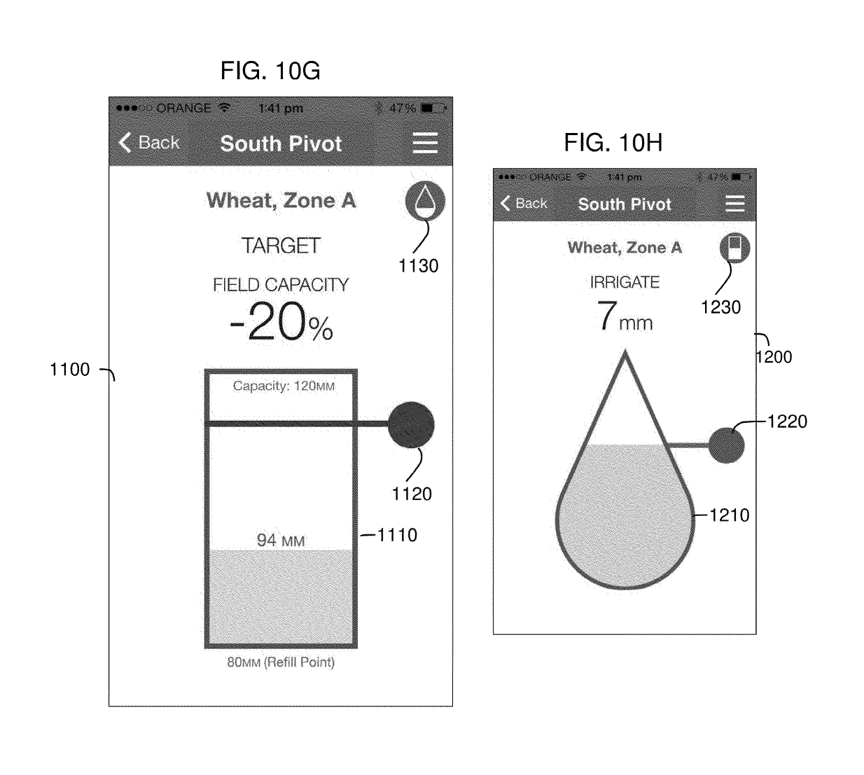

FIG. 10A illustrates a user device 700, FIG. 10B illustrates an embodiment of a multiple zone field irrigation user interface 710 arranged to operate on user device 700 and FIGS. 10C-10H illustrate various screen shots of multiple zone field irrigation user interface 710 displayed on a display 720 of user device 700. FIGS. 10A-10H are described herein together. Multiple zone field irrigation user interface 710 is denoted herein as an Automated Differential Irrigation Planning App (ADIPA) 710. User device 700 comprises: display 720; a processor 730; a memory 740; a user input device 750; and a communications module 760. In one embodiment, display 720 comprises a touch screen and user input device 750 is implemented as the touch screen of display 720. In another embodiment, user device 700 is implemented as a smart phone. In one embodiment, communications module 760 comprises one of an antenna and a wired connection to a network, optionally the Internet. ADIPA 710 comprises: an input module 770; a display module 780; and an irrigation adjustment module 790. In one embodiment, input module 770, display module 780 and irrigation adjustment module 790 each comprise computer code which is implemented by processor 730, the computer code stored on memory 740.

As described above, differential irrigation planning is a complex process. It is a process which creates frequently updated irrigation maps that determines exactly how much water should be optimally irrigated onto each part of a field at any point in time. At present no method exists to automate this process.

An desired element of automating irrigation planning is empowering a user to interact with the system, easily reviewing and fine-tuning the system's recommendations, to produce the finalized irrigation map plan.

In operation, input module 770 is arranged to receive an indication of each of a plurality of sensors. As described above, each sensor is arranged to output an indication of an irrigation status of a respective one of a plurality of zones of one of a plurality of fields. In one embodiment, as described above, each zone has a sensor node comprising a plurality of sensors. As illustrated in screen shot 800 of FIG. 10C, display module 780 is arranged to control processor 730 to display on display 720 a farm view showing a graphical illustration of a plurality of fields 810, 820 and 830, which allows a user to view at a glance the irrigation status of the multiple fields 810, 820, 830 in a farm.

In one embodiment, each of fields 810, 820 and 830 is color coded responsive to the indications received from the plurality of sensors of the field, each color representing a particular irrigation status of the respective field. In one non-limiting embodiment, there are 3 color options: red; yellow; and green. A red color indicates that the particular field requires irrigation. A yellow color indicates that the particular field will soon need irrigation, within a predetermined time period. A green color indicates that the particular field does not require irrigation. In the illustrated screen shot 800, field 810 is depicted in red, indicating to the user that it requires irrigation, field 820 is depicted in yellow, indicating that it will soon require irrigation, and field 830 is depicted in green, indicating to the user that it does not require irrigation.

In one embodiment, a field is defined as needing irrigation, and hence presented in red, even though not the entire the entire field requires irrigation and only one zone of the field requires irrigation while other zones do not. The entire field 810 is thus presented in red in order to draw the attention of the user thereto, as opposed to fields that do not require irrigation, such as field 830 which is presented in green.

In one embodiment, display module 780 is further arranged to control processor 730 to display on display 720, over the graphical illustration of each field 810, 820 and 830, an informational graphical illustration associated with the received indication of the output of the sensor of the one of the plurality of zones of the respective field exhibiting the lowest soil moisture level. The information graphical illustration will be described below in relation to screen shot 900. Particularly, as will be described below, one or more data elements relating to soil moisture level and irrigation status are illustrated. These are in one embodiment presented as an iconized graphic representation, illustrating the current moisture of one or more soil-topography regions within that field, relative to the field-capacity value and refill-point value thereof. In another embodiment, the current soil moisture of a soil-topography region within the field is presented relative to an irrigation target which the user sets, the irrigation target optionally being based at least in part on the soil water holding capacity properties of this soil-topography region.

In one embodiment, display module 780 is further arranged to control processor 730 to display on display 720 a view navigation toolbar 840. Responsive to a user input, such as a tap, at view navigation toolbar 840, fields 810, 820 and 830 can be presented as a map, as illustrated, or as a data list (not shown). In one embodiment, fields 810, 820 and 830 presented in the list are color coded similar to the illustrated map view. In another embodiment, responsive to the user input at view navigation toolbar 840, display module 780 is arranged to control processor 730 to display on display 720 an irrigation plan for each of fields 810, 820 and 830 (not shown).

Responsive to a predetermined user gesture on the graphical illustration of one of fields 810, 820 and 830, display module 780 is further arranged to control processor 730 to display on display 720 a graphical illustration of the selected field split into a plurality of zones. FIG. 10D illustrates a screen shot 900 of a graphical illustration of field 810 split into zones 910 and 920 and FIG. 10E illustrates a close up view of a portion of screen shot 900. As illustrated, in one embodiment multiple soil-topography irrigation zones, such as zone-A 910 and zone-B 920 are displayed on display 720. In this example, zone-A 910 is displayed in red indicating that it requires irrigation and zone-B 920 is displayed in green indicating that it does not require irrigation.

Soil-topography zones 910 and 920 are in one preferred embodiment based at least in part on an automated analysis of an electromagnetic (EM) map of field 810, or a soil-type map of field 810, integrated with an automated analysis of topographical features of field 810, and of a determination of the soil type in each of zones 910 and 920.

The determination of the soil type in each zone may preferably be an automated determination, which does not require laboratory analysis of a soil sample. In one embodiment, this determination is based on an analysis of sequential soil-moisture measurements in the field, which thereby determines a pattern that is typical of a soil type and may differentiate it from other soil types. This pattern analysis may be based at least in part on recognizing a soil drying pattern typical of a soil type. The pattern analysis may also be based on identifying a pattern of a soil of a specific field or zone and deducing its specific water-holding properties. In one embodiment, the system determines the general type of soil in a zone, such as ‘clay’, and deduces from that the water holding properties, such as field capacity and refill point of generic ‘clay’, and uses these properties for this field. In another embodiment, the system determines not only that the soil in this field is generally ‘clay’, but also determines the exact make of the clay in the field by assessing its specific water holding capacity properties directly from analysis of sequential soil moisture measurements, including but not limited to a soil moisture drying curve. In one embodiment, the soil type determinations are performed by ADIPA 710 using a dedicated module (not shown). In another embodiment, the soil type determinations are performed by an external system in communication with ADIPA 710 via communications module 760 of user device 700.

Display module 780 is further arranged to control processor 730 to display on display 720 informational graphical illustrations 930 and 940. Particularly, informational graphical illustration 930 is displayed over soil-topography zone 910 and information graphical illustration 940 is displayed over soil-topography zone 920, optionally illustrated as information bubbles.

Within informational graphical illustration 930, two iconized elements are displayed: a bar graphic representation 950 and a drop graphic representation 960. The bar graphic representation 950 graphically displays a relation between a current soil moisture level in soil-topography zone 910 relative to a field-capacity value and a refill-point value, both of soil-topography zone 910. The drop graphic representation 960 graphically displays an amount of irrigation recommended by the system for a next irrigation event of soil-topography zone 910 relative to a maximal amount of irrigation in an irrigation event, as determined by the user. Numeral 955 designates the current soil moisture level in soil-topography zone 910. In one embodiment, numeral 955 represents an integration of a plurality of soil moisture measurements taken at different depths, such as two readings taken at two depths, or three readings taken at 3 depths. In another embodiment, numeral 955 is a number of volume units of water within a predetermined length of depth of soil, such as square millimetres or square inches, in a meter or another predetermined length measurement unit, of soil. In another preferred embodiment, numeral 955 represents an integration of soil moisture readings taken by several sensors, in order to increase the measurement accuracy. Numeral 365 designates the amount of irrigation recommended by the system for the next irrigation event of soil-topography zone 910. Bar graphic representation 970, drop graphic representation 980, and numerals 975 and 985 are similar to elements 950, 960, 955 and 965, respectively with the exception that they are related to soil-topography zone 920 and are displayed within informational graphical illustration 940.

As illustrated, informational graphical illustration 930 is colored red, since soil-topography zone 920 requires irrigation, whereas informational graphical illustration 940 is colored green since soil-topography zone 920 doesn't require irrigation. Particularly, as illustrated, bar graphic representation 950 depicts a bar that appears near-empty, indicating that soil-topography zone 910 requires irrigation. Bar graphic representation 970 depicts a bar that is a bit more than half full, indicating that soil-topography zone 920 doesn't require irrigation. Additionally, as illustrated, drop graphic representation 960 is illustrated as being half full, indicating that half of the maximum irrigation amount is required for soil-topography zone 910. Drop graphic representation 980 is empty and ‘crossed-out’, indicating that no irrigation is required from soil-topography zone 920. As described above, numerals 955, 965, 975 and 985 provide numerical values for the bar and drop graphic representations 950, 960, 970 and 980, respectively. It is noted that the numerical values by themselves may provide a clear picture of the irrigation status, due reasons such as soil type. For example, the soil moisture level of soil-topography zone 910 is indicated by numeral 955 as 110 millimeters of water within 1 meter of soil and the soil moisture level of soil-topography zone 920 is indicated by numeral 975 as 120 millimeters of water within 1 meter of soil. Although the difference between the soil moisture levels of soil-topography zones are small, the color coding and the bar and drop representations 950, 960, 970 and 980 show that soil-topography zone 910 requires irrigation while soil-topography zone 920 doesn't require irrigation.

Thus, the above differences—in color, in bar graphic shape, in drop graphic shape, and in numerical value—provide the user an effective instant comprehensive understanding of the complex underlying data. Particularly, at a single glance the user knows: (a) whether a zone is green, yellow or red, i.e. whether it doesn't require irrigation, will soon require irrigation, or requires irrigation now; (b) how saturated is the soil (using a graphic metaphor of ‘how full is the glass of water’), in terms that are relevant to farmers, that is—the span between field capacity and refill point; and (c) how much, if any, irrigation should be provided relative to a maximal amount of irrigation used in an irrigation event.

In one embodiment, display module 780 is further arranged to control processor 730 to display on display 720 a schedule time bar 990, a field indicator bar 995 and a graph selector 997. Schedule time bar 990 is arranged to show the date and/or time of the next scheduled irrigation event for the displayed field. Field indicator bar 995 is arranged to show the name of the current field being viewed. Responsive to a predetermined user gesture at graph selector 997, such as a tap, display module 780 is arranged to control processor 730 to display on display 720 a graph 1010 of a history of the soil-moisture content of soil-topography zone 910 and a graph 1020 of a history of the soil-moisture content of soil-topography zone 920, as illustrated in screen shot 1000 of FIG. 10F. As illustrated, graph 1010 is colored red to indicate that soil-topography zone 910 currently requires irrigation and graph 1020 is colored green to indicate that soil-topography zone 920 doesn't currently require irrigation. Display module 780 is further arranged to control processor 730 to display on display 720 a map selector 1030. Responsive to a predetermined user gesture at map selector 1030, such as a tap, display module 780 is arranged to control processor 730 to switch the view on display 720 to a map view as described above in relation to screen shot 900.

Responsive to a predetermined user gesture addressed to any one of informational graphical illustrations 930 and 940, such as a tap, display module 780 is arranged to control processor 730 to display on display 720 a Set Irrigation Target screen or a Set Irrigation Amount screen, as illustrated respectively in screen shot 1100 of FIG. 10G and in screen shot 1200 of FIG. 10H. As illustrated in screen shot 1100, responsive to a user gesture addressed to bar graphic representation 950 or 970, an actionable graphical illustration 1110 is displayed in the Set Irrigation Target screen. In one embodiment, actionable graphical illustration 1110 comprises a bar graphic representation. Actionable graphical illustration 1110 shows the maximum irrigation capacity of the respective soil-topography zone, the current soil moisture level of the soil-topography zone and the currently planned irrigation target of the soil-topography zone, i.e. the expected soil moisture level after the next irrigation event. The planned irrigation target is shown by a slider 1120. Slider 1120 is arranged to be moved vertically along the bar graphic representation, responsive to a predetermined user gesture at slider 1120, to thereby adjust the irrigation target of the respective soil-topography zone. Irrigation adjustment module 790 is arranged to output an irrigation target adjustment signal via communications module 760. The output irrigation target adjustment signal is arranged to adjust the amount of irrigation provided by a particular one of a plurality of irrigation device, or device sets, to the respective soil-topography zone.

Further displayed in the Set Irrigation Target screen is a toggle command button 1130. Responsive to a predetermined user gesture addressed to toggle command button 1130, optionally a tap, display module 780 is arranged to control processor 730 to switch Set Irrigation Target screen 1100 with Set Irrigation Amount screen 1200, described below.

As illustrated in screen shot 1200, responsive to a user gesture addressed to bar graphic representation 960 or 980, an actionable graphical illustration 1210 is displayed in the Set Irrigation Amount screen. In one embodiment, actionable graphical illustration 1210 comprises a drop graphic representation. Actionable graphical illustration 1210 shows the maximum irrigation amount which can be provided to the respective soil-topography zone and the currently planned irrigation amount for the soil-topography zone, i.e. the amount of irrigation to be provided at the next irrigation event. The planned irrigation amount is shown by a slider 1220. Slider 1220 is arranged to be moved vertically along the drop graphic representation, responsive to a predetermined user gesture at slider 1220, to thereby adjust the irrigation amount provided to the respective soil-topography zone. Irrigation adjustment module 790 is arranged to output an irrigation amount adjustment signal via communications module 760. The output irrigation amount adjustment signal is arranged to adjust the amount of irrigation provided by a particular one of a plurality of irrigation device, or device sets, to the respective soil-topography zone.

Further displayed in the Set Irrigation Amount screen is a toggle command button 1230. Responsive to a predetermined user gesture addressed to toggle command button 1230, optionally a tap, display module 780 is arranged to control processor 730 to switch Set Irrigation Amount screen 1s00 with Set Irrigation Target screen 1100, described above.

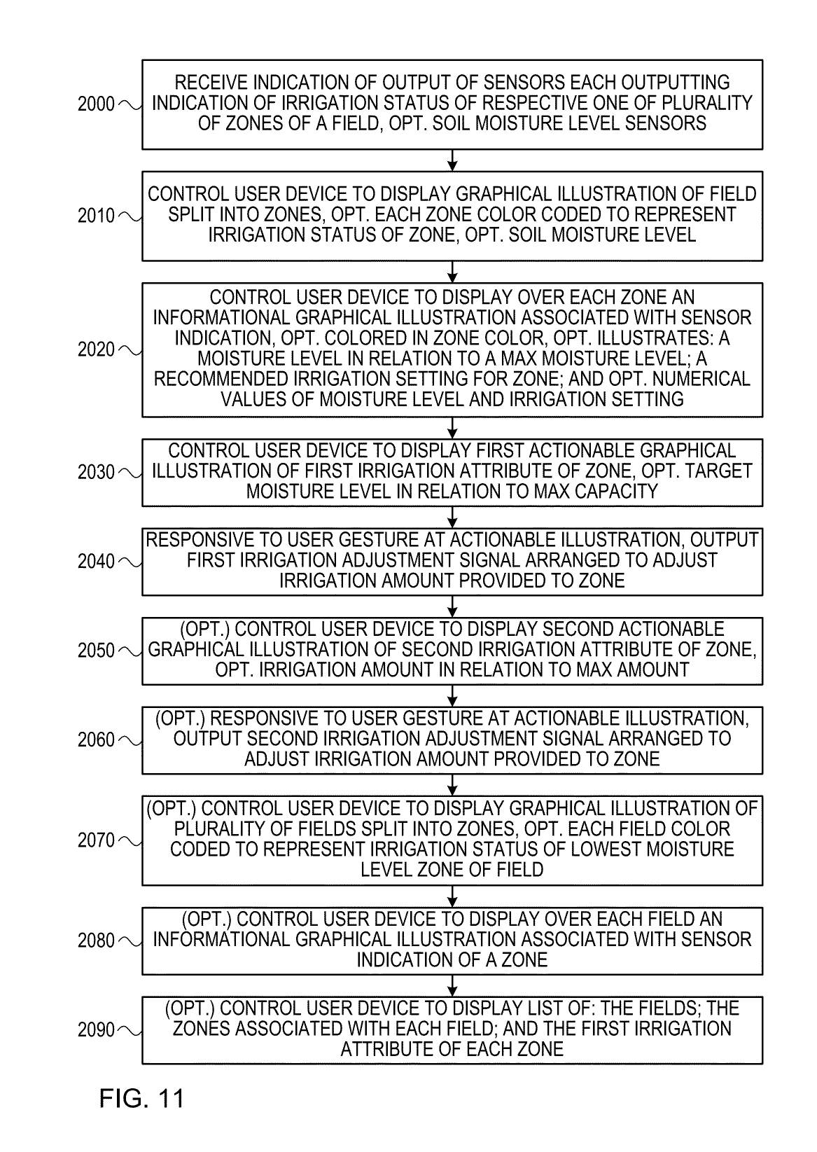

FIG. 11 illustrate a high level flow char of a multiple soil-topography zone field irrigation user interface display method, according to certain embodiments. In stage 2000, an indication of an output of a plurality of sensors is received, each sensor arranged to output an indication of an irrigation status of a respective one of a plurality of soil-topography zones of a field. Optionally, the sensors are each soil moisture level sensors.

In stage 2010, a display of a user device is controlled to display a graphical illustration of the field split into the plurality of soil-topography zones. Optionally, each of the plurality of soil-topography zones of the displayed graphical representation of the field is colored in one of a plurality of colors which represent an irrigation status of the soil-topography zone, each of the plurality of colors indicating a different irrigation status. Optionally, the irrigation status of the respective soil-topography zone comprises the soil moisture level of the soil-topography zone

In stage 2020, the display of the user device of stage 2010 is controlled to display, over the graphical illustration each of the plurality of soil-topography zones, an informational graphical illustration associated with the received indication of the output of the sensor of the respective soil-topography zone. Optionally, each of the displayed informational graphic illustrations is colored in the same color as the associated soil-topography zone of stage 2010. Optionally, the information graphic illustration illustrates: a representation of the current moisture level of the soil of the respective soil-topography zone in relation to a maximum moisture capacity of the soil of the soil-topography zone; and a representation of a recommended irrigation setting of the irrigation device set of the respective soil-topography zone in relation to a maximum irrigation setting of the irrigation device set.

Optionally, the information graphic illustration further illustrates: a numerical value of the current moisture level of the soil of the respective soil-topography zone; and a numerical value of the recommended irrigation setting of the irrigation device set of the respective soil-topography zone.

In stage 2030, the display of the user device of stage 2010 is controlled to display, for each of the plurality of soil-topography zones, a first actionable graphical illustration of a first irrigation attribute of the respective soil-topography zone.

In stage 2040, responsive to a user gesture at any one of the displayed first actionable graphical illustrations, a first irrigation adjustment signal is output. The output first irrigation adjustment signal is arranged to adjust the amount of irrigation provided by a particular one of a plurality of irrigation device sets to the respective soil-topography zone.

In optional stage 2050, the display of the user device is controlled to display, for each of the plurality of soil-topography zones, a second actionable graphical illustration of a second irrigation attribute of the respective soil-topography zone. In optional stage 2060, responsive to a user gesture at any one of the displayed second actionable graphical illustrations of optional stage 2050, a second irrigation adjustment signal is output. The output second irrigation adjustment signal is arranged to adjust the amount of irrigation provided by the particular one of the plurality of irrigation device sets to the respective soil-topography zone. The first irrigation attribute of stage 2030 comprises a target moisture level of soil of the respective soil-topography zone in relation to a maximum moisture capacity of the soil of the soil-topography zone, the target irrigation status adjustable responsive to the user gesture. The second irrigation attribute comprises an irrigation setting of the irrigation device of the respective soil-topography zone in relation to a maximum irrigation setting of the irrigation device, the irrigation setting adjustable responsive to the user gesture.

In optional stage 2070, the user device of stage 2010 is controlled to display a graphical illustration of a plurality of fields. Optionally, each of the plurality of fields of the displayed graphical representation of the field is colored in one of a plurality of colors which represent an irrigation status of the one of the plurality of soil-topography zones of the respective field exhibiting the lowest soil moisture level, each of the plurality of colors indicating a different irrigation status.

In optional stage 2080, the display of the user device of stage 2010 is controlled to display, over the graphical illustration each of the plurality of soil-topography zones, an informational graphical illustration associated with the received indication of the output of the sensor of the one of the plurality of soil-topography zones of the respective field exhibiting the lowest soil moisture level.

In optional stage 2090, the display of the user device is controlled to display a list of: the plurality of fields of stage 2000; the plurality of soil-topography zones associated with each of the plurality of fields; and the first irrigation attribute of each of the plurality of soil-topography zones.

### Computer Program Listing

The following sections of a computer code used in a preferred embodiment of the present disclosure, may be useful for the understanding of the disclosure. It is appreciated the following computer code sections are provided as an example only and are not meant to be limiting.

### Analyze Terrain Attributes

```
library(RSAGA)
# Gaussian filtering of both EM and DEM maps
rsaga.geoprocessor(lib = “grid_filter”, module = 1, param = list(INPUT =
“data/em38.sgrd”,
  RESULT = “data/em38_filtered.sgrd”, RADIUS = 5), show.output.on.console = FALSE)
rsaga.geoprocessor(lib = “grid_filter”, module = 1, param = list(INPUT =
“data/dem.sgrd”,
  RESULT = “data/dem_filtered.sgrd”, RADIUS = 5), show.output.on.console = FALSE)
# SAGA Wetness Index
rsaga.wetness.index(in.dem = “data/dem_filtered.sgrd”, out.wetness.index =
“data/swi.sgrd”,
  show.output.on.console = FALSE)
# Slope
rsaga.slope(in.dem = “data/dem_filtered.sgrd”, out.slope = “data/slope.sgrd”,
  show.output.on.console = FALSE)
# Aspect
rsaga.aspect(in.dem = “data/dem_filtered.sgrd”, out.aspect = “data/aspect.sgrd”,
  show.output.on.console = FALSE)
```

### Integration

```
# Load libraries
library(raster)
# Path to raster files
dem <- raster(“data/dem_filtered.sdat”)
em38 <- raster(“data/em38_filtered.sdat”)
swi <- raster(“data/swi.sdat”)
slope <- raster(“data/slope.sdat”)
aspect <- raster(“data/aspect.sdat”)
# Stack rasters together
st <- stack(dem, em38, swi, slope, aspect)
# Sort layer names out
names(st) <- c(“dem”, “em38”, “swi”, “slope”, “aspect”)
# Make sure your mask is right
msk <- rasterize(bnd, dem)
## Found 1 region(s) and 1 polygon(s)
st <- mask(st, mask = msk)
plot(st)
# Convert RasterStack to data.frame
spdf <- as(st, “SpatialPixelsDataFrame”)
## Classification on attributes
# In thic case we put slope and aspect out
attributes <- c(“dem”, “em38”, “swi”)
n.clust <- 3
# Here we use k-means
clust.res <- kmeans(x = subset(spdf@data, select = attributes), centers = n.clust,
  iter.max = 1000)
# Setting the names of the clusters using simple lettering
spdf$cluster <- clust.res$cluster
spdf$mgt <- factor(spdf$cluster)
levels(spdf$mgt) <- LETTERS[1:n.clust]
# Convert back to RasterStack
st <- stack(spdf)
plot(raster(st, “mgt”), col = topo.colors(3))
# Write to Geotiff
writeRaster(raster(st, “mgt”), “mgt_zones.tif”, overwrite = TRUE)
## class : RasterLayer
## dimensions : 339, 251, 85089 (nrow, ncol, ncell)
## resolution : 5, 5 (x, y)
## extent : 1502175, 1503430, 5127390, 5129085 (xmin, xmax, ymin, ymax)
## coord. ref. : NA
## data source : /home/pierre/Dropbox/tmp/varigate/river-block/mgt_zones.tif
## names : mgt_zones
## values : 1, 3 (min, max)
# Convert raster data to Polygons
mgt <- rasterToPolygons(raster(st, “mgt”), dissolve = TRUE)
spplot(mgt)
# Save the management zone polygons
writeOGR(mgt, dsn = “mgt_zones.shp”, layer = “mgt_zones”, driver = “ESRI Shapefile”,
  overwrite_layer = TRUE)
```

### Maps

# Read WSN data
wsn <- read.table(file = “data/wsn_bh.csv”, header = TRUE, as.is = TRUE, sep = “,”)
# Get zone IDs
zone_ids <- unique(wsn$zone)
# Affect IDs to spatial data
mgt$zone <- zone_ids
# remove the existing fields as they are useless now
mgt$value <- NULL
# Data manipulation
library(stringr)
library(reshape2)
library(lubridate)
wsn_df <- melt(wsn, c(“zone”, “variable”, “units”, “depthcm”))
head(wsn_df)

| ## | zone | variable | units | depthcm | variable | value |
|---|---|---|---|---|---|---|
| ## 1 | z1 | mcv | percent | 20 | X31.10.2011 | 12 |
| ## 2 | z2 | mcv | percent | 20 | X31.10.2011 | 13 |
| ## 3 | z3 | mcv | percent | 20 | X31.10.2011 | 37 |
| ## 4 | z1 | fc | percent | 20 | X31.10.2011 | 0 |
| ## 5 | z2 | fc | percent | 20 | X31.10.2011 | 0 |
| ## 6 | z3 | fc | percent | 20 | X31.10.2011 | 0 |

# There are two columns with the same name so let's change the second one
# to ‘date’
names(wsn_df)[5] <- “date”
# Removing the ‘X’ in front of the dates
wsn_df$date <- str_replace(wsn_df$date, “X”, “”)
# Convert strings to time objects
wsn_df$date <- dmy(wsn_df$date, tz = “NZ”)
# The dynamic variables are ‘mcv’ and ‘smd’ , the rest is fixed for each
# zone and obtained from the soil physics lab
idx <- which(wsn_df$variable %in% c(“fc”, “rp”, “wp”))
soil_physics <- wsn_df[idx, ]
wsn_realtime <- wsn_df[−idx, ]
# We can plot the realtime WSN data
library(ggplot2)
# Produce a plot
p_wsn <- ggplot(wsn_realtime) + geom_line(aes(x = date, y = value, colour = zone)) +
facet_grid(depthcm ~ variable)
print(p_wsn)

### Irrigation Logic

Let's first load the libraries we need:

library(raster)
library(rgdal)
library(plyr)
library(lubridate)
library(ggplot2)
library(RColorBrewer)
library(gridExtra)

### Soil Characterization

The characteristics of the various soil types can be read from a stand-alone look-up table, soil_lut.csv:

# Read soil look-up table
soil_lut <- read.csy(“data/soil_lut.csy”, stringsAsFactors = FALSE)
print(soil_lut)

| ## | soil | fc | pwp | rp |
|---|---|---|---|---|
| ## 1 | sand | 10 | 5 | 7.5 |
| ## 2 | loamy sand | 12 | 5 | 8.5 |
| ## 3 | sandy loam | 18 | 8 | 13.0 |
| ## 4 | sandy clay loam | 27 | 17 | 22.0 |
| ## 5 | loam | 28 | 14 | 21.0 |
| ## 6 | sandy clay | 36 | 25 | 30.5 |
| ## 7 | silt loam | 31 | 11 | 21.0 |
| ## 8 | silt | 30 | 6 | 18.0 |
| ## 9 | clay loam | 36 | 22 | 29.0 |
| ## 10 | silty clay loam | 38 | 22 | 30.0 |
| ## 11 | silty clay | 41 | 27 | 34.0 |
| ## 12 | clay | 42 | 30 | 36.0 |

This look-up table will give us the hydraulic properties of soil for 12 classes of soil. For example's sake, we will have the following classification:

This can be read from a dedicated file, data/soil_setup.csv, which is generated at the beginning of the season:

# Read the paddock specific file
soil_setup <- read.csy(“data/soil_setup.csy”, stringsAsFactors = FALSE)
# Add soil characteristics
soil_setup <- join(soil_setup, soil_lut, by = “soil”)

There is a maximum soil moisture deficit for each soil, and at each depth. This is given by the available water holding capacity. This can be defined as the difference between field capacity and permanent wilting point. We can add this information:

idx_top <- which(soil_setup$depth == 20)
idx_bottom <- which(soil_setup$depth == 60)
# Update sensor values
soil_setup$smd_max <- NA
soil_setup$smd_max[idx_top] <- 2 * (soil_setup$fc[idx_top] −
soil_setup$pwp[idx_top])
soil_setup$smd_max[idx_bottom] <- 2 * (soil_setup$fc[idx_top] −
soil_setup$pwp[idx_top]) +
4 * (soil_setup$fc[idx_bottom] − soil_setup$pwp[idx_bottom])
soil_setup$smd_max <- -1 * soil_setup$smd_max
print(soil_setup)

| ## | id | zone | depth | soil | fc | pwp | rp | smd_max |
|---|---|---|---|---|---|---|---|---|
| ## 1 | 1 | dry | 20 | sandy loam | 18 | 8 | 13.0 | −20 |
| ## 2 | 1 | dry | 60 | loamy sand | 12 | 5 | 8.5 | −48 |
| ## 3 | 2 | intermediate | 20 | sandy loam | 18 | 8 | 13.0 | −20 |
| ## 4 | 2 | intermediate | 60 | loamy sand | 12 | 5 | 8.5 | −48 |
| ## 5 | 3 | wet | 20 | silty clay loam | 38 | 22 | 30.0 | −32 |
| ## 6 | 3 | wet | 60 | sandy loam | 18 | 8 | 13.0 | −72 |

We will then read the management zones polygons produced earlier:

# Read management zones file
mgt <- readOGR(dsn = “data/mgt_zones.shp”, layer = “mgt_zones”)
## OGR data source with driver: ESRI Shapefile
## Source: “data/mgt_zones.shp”, layer: “mgt_zones”
## with 3 features and 1 fields
## Feature type: wkbMultiPolygon with 2 dimensions
# Re-level zones IDs to use charcteristics
mgt$zone <- factor(mgt$zone, levels = 1:3, labels = c(“wet”, “intermediate”,
“dry”))
summary(mgt)
## Object of class SpatialPolygonsDataFrame
## Coordinates:

| ## | | min | max |
|---|---|---|---|
| ## | x | 1793739 | 1795019 |
| ## | y | 5552504 | 5553359 |

## Is projected: TRUE
## proj4string :
## [+proj=tmerc +lat_0=0 +lon_0=173 +k=0.9996 +x_0=1600000
## +y_0=10000000 +ellps=GRS80 +units=m +no_defs]
## Data attributes:

| ## | wet | intermediate | dry |
|---|---|---|---|
| ## | 1 | 1 | 1 |

### Soil Moisture Data

The WSN data is supposed to be a table with four columns:

timestamp
zone
depth
mcv
2011-09-2909:19:24.000
1
20
41.605
2011-09-2909:19:24.000
1
60
53.212
2011-09-2909:23:39.000
2
20
12.913
2011-09-2909:23:39.000
2
60
32.795
. . .
. . .
. . .
. . .

In this example, we will read such WSN data from a file, wsn_bh.csv. We are using the lubridate library to explicitely store the date and/or time information as a POSIXct object. We are of course using the NZ timezone here.

# Read WSN data
wsn <- read.csv(“data/wsn_bh.csv”, stringsAsFactors = FALSE)
# Re-level zones IDs to proper characteristics
wsn$zone <- factor(wsn$zone, levels = 1:3, labels = c(“dry”, “intermediate”,
“wet”))
# Transform timestamps from characters to time objects
wsn$timestamp <- dmy(wsn$timestamp, tz = “NZ”)
# Add zones field capacity information
wsn <- join(wsn, soil_setup, by = c(“zone”, “depth”))
# Here's what the data looks like
head(wsn)

| ## | timestamp | zone | depth | mcv | id | soil | fc | pwp | rp | smd_max |
|---|---|---|---|---|---|---|---|---|---|---|
| ## 1 | 2011-10-31 | dry | 20 | 12 | 1 | sandy loam | 18 | 8 | 13 | −20 |
| ## 2 | 2011-11-01 | dry | 20 | 11 | 1 | sandy loam | 18 | 8 | 13 | −20 |
| ## 3 | 2011-11-02 | dry | 20 | 11 | 1 | sandy loam | 18 | 8 | 13 | −20 |
| ## 4 | 2011-11-03 | dry | 20 | 11 | 1 | sandy loam | 18 | 8 | 13 | −20 |
| ## 5 | 2011-11-04 | dry | 20 | 11 | 1 | sandy loam | 18 | 8 | 13 | −20 |
| ## 6 | 2011-11-05 | dry | 20 | 13 | 1 | sandy loam | 18 | 8 | 13 | −20 |

### Processing

To facilitate processsing, we are writing two processing functions. The first one does two things. First, it is extracting the raw data from the WSN data for a given timestamp, and then, it is transforming that raw data into the “real” soil moisture status using the soil hydraulic characteristics at any one zone.

```
# Associate soil water status to zones
get_soil_moisture_status <- function(timestamp, zones) {
  # Get the WSN data for the current timestamp
  cur_wsn_df <- wsn[which(wsn$timestamp %within% new_interval(timestamp,
timestamp)),
    ]
  # Join soil information to zones
  zones@data <- join(zones@data, cur_wsn_df, by = “zone”)
  # Update MCV values using the soil data
  zones$mcv_mm <- zones$fc_depth <- zones$smd <- NA
  # First the top sensor
  idx_top <- which(zones$depth == 20)
  idx_bottom <- which(zones$depth == 60)
  # Update sensor values to millimeters from volumetric values
  zones$mcv_mm[idx_top] <- zones$mcv[idx_top] * 2
  zones$mcv_mm[idx_bottom] <- 2 * zones$mcv[idx_top] + 4 *
zones$mcv[idx_bottorn]
  # Compute FC values between 0-20cm and 0-60cm
  zones$fc_depth[idx_top] <- 2 * zones$fc[idx_top]
  zones$fc_depth[idx_bottom] <- 2 * zones$fc[idx_top] + 4 * zones$fc[idx_bottom]
  # Compute soil moisture deficit
  zones$smd <- zones$mcv_mm - zones$fc_depth
  # Compute water left in soil
  zones$water_left <- zones$rp - zones$smd
  # Return a SpatialPolygonDataFrame object
  zones
}
# Test
res <- get_soil_moisture_status(timestamp = wsn$timestamp[1], zones = mgt)
summary(res)
## Object of class SpatialPolygonsDataFrame
## Coordinates:
```

| ## | | min | max |
|---|---|---|---|
| ## | x | 1793739 | 1795019 |
| ## | y | 5552504 | 5553359 |

## Is projected: TRUE
## proj4string :
## [+proj=tmerc +lat_0=0 +lon_0=173 +k=0.9996 +x_0=1600000
## +y_0=10000000 +ellps=GRS80 +units=m +no_defs]
## Data attributes:

| ## | zone | | timestamp | | depth | | mcv | |
|---|---|---|---|---|---|---|---|---|
| ## | wet: | 2 | Min.: | 2011-10-31 | Min.: | 20 | Min.: | 12.0 |
| ## | intermediate: | 2 | 1st Qu.: | 2011-10-31 | 1st Qu.: | 20 | 1st Qu.: | 13.0 |
| ## | dry: | 2 | Median: | 2011-10-31 | Median: | 40 | Median: | 14.0 |

| ## | | | Mean: | 2011-10-31 | Mean: | 40 | Mean: | 22.2 |
|---|---|---|---|---|---|---|---|---|
| ## | | | 3rd Qu.: | 2011-10-31 | 3rd Qu.: | 60 | 3rd Qu.: | 31.5 |
| ## | | | Max.: | 2011-10-31 | Max.: | 60 | Max.: | 43.0 |
| ## | id | | soil | | fc | | pwp | |
| ## | Min.: | 1.00 | Length: | 6 | Min.: | 12.0 | Min.: | 5.00 |
| ## | 1st Qu.: | 1.25 | Class: | character | 1st Qu.: | 13.5 | 1st Qu.: | 5.75 |
| ## | Median: | 2.00 | Mode: | character | Median: | 18.0 | Median: | 8.00 |
| ## | Mean: | 2.00 | | | Mean: | 19.3 | Mean: | 9.33 |
| ## | 3rd Qu.: | 2.75 | | | 3rd Qu.: | 18.0 | 3rd Qu.: | 8.00 |
| ## | Max.: | 3.00 | | | Max.: | 38.0 | Max.: | 22.00 |
| ## | rp | | smd_max | | smd | | fc_depth | |
| ## | Min.: | 8.50 | Min.: | −72 | Min.: | −12.0 | Min.: | 36.0 |
| ## | 1st Qu.: | 9.62 | 1st Qu.: | −48 | 1st Qu.: | −9.5 | 1st Qu.: | 46.0 |
| ## | Median: | 13.00 | Median: | −40 | Median: | −5.0 | Median: | 80.0 |
| ## | Mean: | 14.33 | Mean : | −40 | Mean: | 11.3 | Mean: | 77.3 |
| ## | 3rd Qu.: | 13.00 | 3rd Qu.: | −23 | 3rd Qu.: | 1.0 | 3rd Qu.: | 84.0 |
| ## | Max.: | 30.00 | Max. : | −20 | Max.: | 98.0 | Max.: | 148.0 |

| ## | mcv_mm | | water_left | |
|---|---|---|---|---|
| ## | Min.: | 24.0 | Min.: | −85.0 |
| ## | 1st Qu.: | 38.0 | 1st Qu.: | 9.0 |
| ## | Median: | 75.0 | Median: | 19.8 |
| ## | Mean: | 88.7 | Mean: | 3.0 |
| ## | 3rd Qu.: | 83.5 | 3rd Qu.: | 24.5 |
| ## | Max.: | 246.0 | Max.: | 32.0 |

The second function is the irrigation logic algorithm. It takes the soil moisture status at 20 cm and at 50 cm, and spits out a recommendation.

```
# Irrigation logic function
irrigation_logic <- function(smd_top, smd_bottom, smd_max_top, smd_max_bottom) {
  if (smd_top >= 0 & smd_bottom >= 0)
    res <- 0
  if (smd_top >= 0 & smd_bottom < 0)
    res <- 0
  if (smd_top < 0 & smd_bottom >= 0)
    res <- ifelse(−1 * smd_top >= smd_max_top, −1 * smd_top, smd_max_top)
  if (smd_top < 0 & smd_bottom < 0) {
    smd_top <- ifelse(smd_top >= smd_max_top, smd_top, smd_max_top)
    smd_bottom <- ifelse(smd_bottom >= smd_max_bottom, smd_bottom,
smd_max_bottom)
    idx <- which.min(c(smd_top, smd_bottom))
    res <- −1 * c(smd_top, smd_bottom)[idx]
  }
  res
}
# Test
irrigation_logic(smd_top = −7, smd_bottom = 0, smd_max_top = −10, smd_max_bottom
= −12)
## [1] 7
irrigation_logic(smd_top = 17, smd_bottom = −9, smd_max_top = −10,
smd_max_bottom = −12)
## [1] 10
```

Finally everything can be processed inside a single list. The result of the code below is a list of SpatialPolygonsDataFrame containing the recommendation. There's one for each timestamp available in the WSN data.

```
bh_irrigation <- Ilply(unique(wsn$timestamp), function(t) {
  # Get current moisture data
  cur_mgt <- get_soil_moisture_status(timestamp = t, zones = mgt)
  # Apply the irrigation decision
  irrigation_decision <- ddply(cur_mgt@data, .(zone), function(x) {
    smd_top <- x[which(x$depth == 20), “smd”]
    smd_bottom <- x[which(x$depth == 60), “smd”]
    smd_max_top <- x[which(x$depth == 20), “smd_max”]
    smd_max_bottom <- x[which(x$depth == 60), “smd_max”]
    smd_df <- data.frame(smd_top = smd_top, smd_bottom = smd_bottom,
smd_max_top = smd_max_top,
      smd_max_bottom = smd_max_bottom)
    decision <- irrigation_logic(smd_top, smd_bottom, smd_max_top,
smd_max_bottom)
    data.frame(zone = unique(x$zone), timestamp = unique(x$timestamp), decision =
decision)
  })
  # Merge decision back to the zones
  res <- mgt
  res@data <- join(res@data[, “zone”, drop = FALSE], irrigation_decision,
    by = “zone”)
  # Return zones object
  res
})
names(bh_irrigation) <- unique(wsn$timestamp)
```

### Plotting

```
msk <- raster(“data/swi.sdat”)
msk[lis.na(msk)] <- 1
writeRaster(msk, “data/msk.tif”)
Anyway, back to my maps:
# Plotting function
#
plot_irrigation <- function(t, msk, range_data = c(0,10)){
  # If a char is passed to the function
  if(lis.POSIXt(t)) t <- dmy(t, tz = “NZ”)
  idx <- which(names(bh_irrigation) == as.character(t))
  cur_spdf <- bh_irrigation[[idx]]
  # Switching to raster for more efficient visualisation
  cur_raster <- rasterize(cur_spdf, msk)
  cur_raster <- na.exclude(as.data.frame(cur_raster, xy = T))
  # Create plot object
  p <- ggplot(cur_raster, aes(x=x, y=y)) +
    geom_raster(aes(fill = decision)) +
    scale_fill_gradientn(
      “Recommended\nIrrigation (mm)”,
      colours=brewer.pal(n=5, name=“YIGnBu”),
      limits = range_data
      ) +
    labs(x= E (m)”, y = “N (m)”, title = t) +
    coord_equal( )
  p
}
# Find the min and max recommendations for the whole dataset
# so we use a fixed colour scale
min_range <- min(laply(bh_irrigation, function(x) min(x$decision)))
max_range <- max(laply(bh_irrigation, function(x) max(x$decision)))
# Get the raster mask of the paddock
# (I'm using raster rather than vector data for
# plotting purposes, it's faster)
msk <- raster(‘data/mask.tif’)
# Generate plots
plots <- Ilply(
  # Here I only take a subset of the available date
  # to save on processing time
  .data = unique(wsn$timestamp)[50:55],
  .fun = plot_irrigation,
  msk = msk, range_data = c(min_range, max_range)
)
# You can either print maps one by one....
# Here the first map
print(plots[[1]])
```

### Soil Type Recognition

```
library(plyr)
library(stringr)
library(reshape2)
library(ggplot2)
library(caret)
## Loading required package: cluster Loading required package: foreach
## Loading required package: lattice
setwd(“/home/pierre/DropboxAmp/varigate/curves/code”)
# Load NSD
nsd <- read.csv(“../datainsd.csv”)
# Select attributes
nsd <- subset(nsd, select = c(“Type.qualifier”, “X0.025.bar”, “X0.05.bar”, “X0.1.bar”,
  “X0.2.bar”, “X0.4.bar”, “X1.bar”, “X15.bar”))
# Remove NAs nsd$texture <- str_replace(nsd$texture, “, as.character(NA))
nsd <- na.exclude(nsd)
# Add some kind of ID
nsd$id <- 1:nrow(nsd)
# Re-arrange data
nsd <- melt(nsd, c(“id”, “Type.qualifier”))
# Better colnames
names(nsd) <- c(“id”, “texture”, “pressure”, “moisture”)
nsd$texture <- factor(nsd$texture)
# Better pressure values
nsd$pressure <- as.numeric(as.character(str_replace(str_replace(nsd$pressure,
  “X”, “”), “.bar”, “”)))
# Group similar groups
nsd$texture <- str_replace(nsd$texture, “CLAY LOAM, PALE TOPSOIL PHASE”, “CLAY LOAM”)
nsd$texture <- str_replace(nsd$texture, “MOTTLED SILT LOAM”, “SILT LOAM”)
nsd$texture <- str_replace(nsd$texture, “PEAT DRAINED”, “PEAT”)
nsd$texture <- str_replace(nsd$texture, “PEAT UNDRAINED”, “PEAT”)
nsd$texture <- factor(nsd$texture)
ggplot(nsd) + geom_line(aes(x = pressure, y = moisture, group = id, colour = texture),
  alpha = 0.2) + geom_point(aes(x = pressure, y = moisture, group = id, colour = texture),
  alpha = 0.2) + # geom_smooth(aes(x=pressure, y=moisture, colour=texture), method = Im, se
=
# TRUE, lwd=2) +
scale_colour_discrete(“Texture”) + scale_x_log10( ) + labs(x = “Pressure (bar)”,
  y = “Moisture content (%)”) + theme_bw( )
pmax <- 0.5
nsd <- subset(nsd, pressure <= pmax)
ggplot(nsd) + geom_line(aes(x = pressure, y = moisture, group = id, colour = texture),
  alpha = 0.2) + geom_point(aes(x = pressure, y = moisture, group = id, colour = texture),
  alpha = 0.2) + geom_smooth(aes(x = pressure, y = moisture, colour = texture),
  method = Im, se = TRUE, lwd =+ 2) + scale_colour_discrete(“Texture”) + scale_x_log10( ) +
  labs(x = “Pressure (bar)”, y = “Moisture content (%)”) + theme_bw( )
fits <- ddply(nsd, .(id), function(x) {
  fit <- Im(moisture ~ pressure, data = x)
  data.frame(texture = as.character(x$texture), intercept = fit$coefficients[1],
    slope = fit$coefficients[2])
})
m_fits <- melt(fits, c(“id”, “texture”))
ggplot(m_fits) + geom_boxplot(aes(x = texture, y = value)) + facet_wrap(~variable,
  scales = “free_y”)
pct_calib <- 0.5
set.seed(20130920)
idx_calib <- sample(1:nrow(fits), size = floor(pct_calib * nrow(fits)), replace = FALSE)
calib <- fits[idx_calib, ]
valid <- fits[−idx_calib, ]
ctrl <- trainControl(method = “repeatedcv”, repeats = 5)
fit <- train(texture ~ intercept + slope, data = fits, method = “C5.0”, tuneLength = 10,
  trControl = ctrl)
## Loading required package: class
summary(fit)
##
## Call:
## C5.0.default(x = “scrubbed”, y = “scrubbed”, trials = 1, rules =
## “CF”, “minCases”, “fuzzyThreshold”, “sample”, “earlyStopping”,
## “label”, “seed”)))
##
##
## C5.0 [Release 2.07 GPL Edition] Mon Sep 23 09:02:19 2013
## -------------------------------
##
## Class specified by attribute ‘outcome’
##
## Read 1220 cases (3 attributes) from undefined.data
##
## No attributes winnowed
##
## Decision tree:
##
## intercept > 59.85417:
## : . . . slope > −24.79032: CLAY LOAM (75)
## : slope <= −24.79032:
## : : . . . intercept > 66.29583: PEAT (150)
## : intercept <= 66.29583:
## : : . . . slope <= −42.33333: SILT LOAM (20)
## : slope > −42.33333:
## : : . . . intercept <= 61.45417: PEAT (10)
## : intercept > 61.45417: SILT LOAM (5)
## intercept <= 59.85417:
## : . . . intercept <= 40.39167:
##  : . . . intercept > 33.6125: SILT LOAM (255)
##  : intercept <= 33.6125:
##  : : . . . intercept <= 31.48333: SILT LOAM (25)
##  : intercept > 31.48333: LOAMY SAND (5)
##  intercept > 40.39167:
##  : . . . slope <= −30.80645: SILT LOAM (180)
##  slope > −30.80645:
##  : . . . intercept <= 51.30416:
##  : . . . slope <= −27.02688:
##  : : . . . intercept <= 47.1125: CLAY LOAM (15)
##  : : intercept > 47.1125: SILT LOAM (15)
##  : slope > −27.02688:
##  : : . . . intercept <= 40.65:
##  : : . . . intercept > 40.4: CLAY LOAM (5)
##  : : intercept <= 40.4:
##  : : : . . . slope <= −18.71505: CLAY LOAM (5)
##  : : slope > −18.71505: SILT LOAM (5)
##  : intercept > 40.65:
##  : : . . .slope <= −8.827957: SILT LOAM (295)
##  : slope > −8.827957:
##  : : . . . intercept > 45.825: SILT LOAM (40)
##  : intercept <= 45.825:
##  : : . . . intercept <= 43.39583: SILT LOAM (10)
##  : intercept > 43.39583: CLAY LOAM (10)
##  intercept > 51.30416:
##  : . . . slope > −5.564516: SILT LOAM (15)
##  slope <= −5.564516:
##  : . . . intercept <= 52.3625: CLAY LOAM (10)
##  intercept > 52.3625:
##  : . . . intercept <= 53.8375: SILT LOAM (20)
##  intercept > 53.8375:
##  : . . . intercept <= 54.42083: CLAY LOAM (5)
##  intercept > 54.42083:
##  : . . . slope <= −16.45161: SILT LOAM (15)
##  slope > −16.45161:
##  : . . . slope <= −14.43011: CLAY LOAM (5)
##  slope > −14.43011:
##  : . . . slope > −7.564516: CLAY LOAM (5)
##  slope <= −7.564516:
##  : . . . intercept > 55.72917: SILT LOAM (10)
##  intercept <= 55.72917:
##  : . . . intercept <= 55.40833: SILT LOAM (5)
##  intercept > 55.40833: CLAY LOAM (5)
##
##
## Evaluation on training data (1220 cases):
##
##
##  Decision Tree
##  ----------------
##  Size Errors
##
##  28 0( 0.0%) <<
##
##
##  (a) (b) (c) (d) <-classified as
##  ---- ---- ---- ----
##  5 (a): class LOAMY SAND
##  91 (b): class SILT LOAM
##  140 (c): class CLAY LOAM
##  160 (d): class PEAT
##
##
## Attribute usage:
##
## 100.00% intercept
##  76.64% slope
##
##
## Time: 0.0 secs
postResample(obs = valid$texture, pred = predict(fit, newdata = valid))
## Accuracy Kappa
```

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination. In particular, the invention has been described with an identification of each powered device by a class, however this is not meant to be limiting in any way. In an alternative embodiment, all powered device are treated equally, and thus the identification of class with its associated power requirements is not required.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A multiple soil-topography zone field irrigation user interface comprising:
an input module arranged to receive an indication of an output of each of a plurality of sensors, each sensor arranged to output an indication of an irrigation status of a respective one of a plurality of soil-topography zones of a field;
a display module arranged to:
control a display of a user device to display a graphical illustration of the field split into the plurality of soil-topography zones;
control the display of the user device to display, over the graphical illustration each of the plurality of soil-topography zones, an informational graphical illustration associated with the received indication of the output of the sensor of the respective soil-topography zone; and
control the display of the user device to display, for each of the plurality of soil-topography zones, a first actionable graphical illustration of a first irrigation attribute of the respective soil-topography zone, and
an irrigation adjustment module arranged, responsive to a user gesture at any one of said displayed first actionable graphical illustrations, to output a first irrigation adjustment signal,
wherein said output first irrigation adjustment signal is arranged to adjust the amount of irrigation provided by a particular one of a plurality of irrigation devices to the respective soil-topography zone.

2. The user interface of claim 1, wherein each of the plurality of soil-topography zones of said displayed graphical representation of the field is colored in one of a plurality of colors which represent an irrigation status of the soil-topography zone, each of the plurality of colors indicating a different irrigation status.

3. The user interface of claim 2, wherein each of said displayed informational graphic illustrations is colored in the same color as the associated soil-topography zone.

4. The user interface of claim 1, wherein said display module is further arranged to control the display of the user device to display, for each of the plurality of soil-topography zones, a second actionable graphical illustration of a second irrigation attribute of the respective soil-topography zone,
wherein said irrigation adjustment module is arranged, responsive to a user gesture at any one of said displayed second actionable graphical illustrations, to output a second irrigation adjustment signal,
wherein said second irrigation adjustment signal is arranged to adjust the amount of irrigation provided by the particular one of the plurality of irrigation device sets to the respective soil-topography zone,
wherein said first irrigation attribute comprises a target moisture level of soil of the respective soil-topography zone in relation to a maximum moisture capacity of the soil of the soil-topography zone, said target irrigation status adjustable responsive to the user gesture, and
wherein said second irrigation attribute comprises an irrigation setting of the irrigation device of the respective soil-topography zone in relation to a maximum irrigation setting of the irrigation device, said irrigation setting adjustable responsive to the user gesture.

5. The user interface of claim 1, wherein each of the plurality of sensors comprises a soil moisture level sensor, the irrigation status of the respective soil-topography zone comprising the soil moisture level of the soil-topography zone, and
wherein said information graphic illustration illustrates:
a representation of the current moisture level of the soil of the respective soil-topography zone in relation to a maximum moisture capacity of the soil of the soil-topography zone; and
a representation of a recommended irrigation setting of the irrigation device set of the respective soil-topography zone in relation to a maximum irrigation setting of the irrigation device set.

6. The user interface of claim 5, wherein said information graphic illustration further illustrates:
a numerical value of the current moisture level of the soil of the respective soil-topography zone; and
a numerical value of the recommended irrigation setting of the irrigation device set of the respective soil-topography zone.

7. The user interface of claim 1, wherein each of the plurality of sensors comprises a soil moisture level sensor, the irrigation status of the respective soil-topography zone comprising the soil moisture level of the soil-topography zone,
wherein said display module is further arranged to:
control the user device to display a graphical illustration of a plurality of fields; and
control the display of the user device to display, over the graphical illustration each of the plurality of soil-topography zones, an informational graphical illustration associated with the received indication of the output of the sensor of the one of the plurality of soil-topography zones of the respective field exhibiting the lowest soil moisture level.

8. The user interface of claim 7, wherein each of the plurality of fields of said displayed graphical representation of the field is colored in one of a plurality of colors which represent an irrigation status of the one of the plurality of soil-topography zones of the respective field exhibiting the lowest soil moisture level, each of the plurality of colors indicating a different irrigation status.

9. The user interface of claim 7, wherein said display module is further arranged to control the display of the user device to display a list of:
the plurality of fields;
the plurality of soil-topography zones associated with each of the plurality of fields; and
the first irrigation attribute of each of the plurality of soil-topography zones.

10. A multiple soil-topography zone field irrigation user interface display method, the method comprising:
receiving an indication of an output of a plurality of sensors, each sensor arranged to output an indication of an irrigation status of a respective one of a plurality of soil-topography zones of a field;
controlling a display of a user device to display a graphical illustration of the field split into the plurality of soil-topography zones;
controlling the display of the user device to display, over the graphical illustration each of the plurality of soil-topography zones, an informational graphical illustration associated with the received indication of the output of the sensor of the respective soil-topography zone;
controlling the display of the user device to display, for each of the plurality of soil-topography zones, a first actionable graphical illustration of a first irrigation attribute of the respective soil-topography zone; and
responsive to a user gesture at any one of said displayed first actionable graphical illustrations, outputting a first irrigation adjustment signal,
wherein said output first irrigation adjustment signal is arranged to adjust the amount of irrigation provided by a particular one of a plurality of irrigation device sets to the respective soil-topography zone.

11. The method of claim 10, wherein each of the plurality of soil-topography zones of said displayed graphical representation of the field is colored in one of a plurality of colors which represent an irrigation status of the soil-topography zone, each of the plurality of colors indicating a different irrigation status.

12. The method of claim 11, wherein each of said displayed informational graphic illustrations is colored in the same color as the associated soil-topography zone.

13. The method of claim 10, further comprising:
controlling the display of the user device to display, for each of the plurality of soil-topography zones, a second actionable graphical illustration of a second irrigation attribute of the respective soil-topography zone; and
responsive to a user gesture at any one of said displayed second actionable graphical illustrations, outputting a second irrigation adjustment signal,
wherein said output second irrigation adjustment signal is arranged to adjust the amount of irrigation provided by the particular one of the plurality of irrigation device sets to the respective soil-topography zone,
wherein said first irrigation attribute comprises a target moisture level of soil of the respective soil-topography zone in relation to a maximum moisture capacity of the soil of the soil-topography zone, said target irrigation status adjustable responsive to the user gesture, and
wherein said second irrigation attribute comprises an irrigation setting of the irrigation device of the respective soil-topography zone in relation to a maximum irrigation setting of the irrigation device, said irrigation setting adjustable responsive to the user gesture.

14. The method of claim 10, wherein each of the plurality of sensors comprises a soil moisture level sensor, the irrigation status of the respective soil-topography zone comprising the soil moisture level of the soil-topography zone, and
wherein said information graphic illustration illustrates:
a representation of the current moisture level of the soil of the respective soil-topography zone in relation to a maximum moisture capacity of the soil of the soil-topography zone; and
a representation of a recommended irrigation setting of the irrigation device set of the respective soil-topography zone in relation to a maximum irrigation setting of the irrigation device set.

15. The method of claim 14, wherein said information graphic illustration further illustrates:
a numerical value of the current moisture level of the soil of the respective soil-topography zone; and
a numerical value of the recommended irrigation setting of the irrigation device set of the respective soil-topography zone.

16. The method of claim 10, wherein each of the plurality of sensors comprises a soil moisture level sensor, the irrigation status of the respective soil-topography zone comprising the soil moisture level of the soil-topography zone, the method further comprising:
controlling the user device to display a graphical illustration of a plurality of fields; and
controlling the display of the user device to display, over the graphical illustration each of the plurality of soil-topography zones, an informational graphical illustration associated with the received indication of the output of the sensor of the one of the plurality of soil-topography zones of the respective field exhibiting the lowest soil moisture level.

17. The method of claim 16, wherein each of the plurality of fields of said displayed graphical representation of the field is colored in one of a plurality of colors which represent an irrigation status of the one of the plurality of soil-topography zones of the respective field exhibiting the lowest soil moisture level, each of the plurality of colors indicating a different irrigation status.

18. The method of claim 16, further comprising controlling the display of the user device to display a list of:
the plurality of fields;
the plurality of soil-topography zones associated with each of the plurality of fields; and
the first irrigation attribute of each of the plurality of soil-topography zones.
